(19) United States
(12) Patent Application Publication
(10) Pub. No.: US 2026/0357089 A1
(43) Pub. Date: Nov. 12, 2026

(54) ELECTRODEPOSITABLE COATING COMPOSITIONS COMPRISING CALCINED CLAY

(71) Applicant: PPG Industries Ohio, Inc., Cleveland, OH (US)

(72) Inventors: David Alfred Stone, Pittsburgh, PA (US); Ross Anthony Moretti, Pittsburgh, PA (US); Brendan Joseph Graziano, Allison Park, PA (US); Hyun Wook Ro, Gibsonia, PA (US); Marissa Elizabeth Johnson, Valencia, PA (US)

(73) Assignee: PPG Industries Ohio, Inc., Cleveland, OH (US)

(21) Appl. No.: 19/487,112

(22) PCT Filed: May 28, 2024
(86) PCT No.: PCT/US2024/031233

§ 371 Date: Nov. 24, 2025

Related U.S. Application Data
(60) Provisional application No. 63/504,639, filed on May 26, 2023.

(51) Int. Cl. C09D 5/44

(52) U.S. Cl. CPC C09D 5/4457; C09D 5/4438

(57) ABSTRACT

The present disclosure is directed to an electrodepositable coating composition comprising an active hydrogen-containing, ionic salt group-containing film-forming polymer; a curing agent; at least one organic resinous component different than the active hydrogen-containing, ionic salt group-containing film-forming polymer and curing agent, wherein the organic resinous component has an aliphatic content of at least 60% by weight, based on the total weight of the organic resinous component; a curing catalyst substantially free, essentially free, or completely free of catalytic tin and/or comprising a bismuth-containing curing catalyst, an amine-containing curing catalyst, a zinc-containing curing catalyst, a zirconium-containing catalyst, a cerium-containing catalyst, an amidine-containing catalyst, an imidazole-containing catalyst, and/or a titanium-containing catalyst; and calcined clay pigment. Also disclosed are electrodepositable coating compositions, methods of coating substrates, and uses of electrodepositable coating compositions.

### FIELD

The present disclosure is directed towards an electrodepositable coating composition, coated substrates, methods of coating substrates, coated substrates, and uses of electrodepositable coating compositions.

### BACKGROUND

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodeposition processes are used commercially.

### SUMMARY

The present disclosure provides an electrodepositable coating composition comprising an active hydrogen-containing, ionic salt group-containing film-forming polymer; a curing agent; at least one organic resinous component different than the active hydrogen-containing, ionic salt group-containing film-forming polymer and curing agent, wherein the organic resinous component has an aliphatic content of at least 60% by weight, based on the total weight of the organic resinous component; a curing catalyst comprising a bismuth-containing curing catalyst, an amine-containing curing catalyst, a zinc-containing curing catalyst, a zirconium-containing catalyst, a cerium-containing catalyst, an amidine-containing catalyst, an imidazole-containing catalyst, and/or a titanium-containing catalyst; and calcined clay pigment.

The present disclosure also provides an electrodepositable coating composition comprising an active hydrogen-containing, ionic salt group-containing film-forming polymer; a curing agent; at least one organic resinous component different than the active hydrogen-containing, ionic salt group-containing film-forming polymer and curing agent, wherein the organic resinous component has an aliphatic content of at least 60% by weight, based on the total weight of the organic resinous component; and calcined clay pigment; wherein the electrodepositable coating composition is substantially free, essentially free, or completely free of catalytic tin.

The present disclosure also provides a method of coating a conductive substrate comprising applying the electrodepositable coating composition of the present disclosure to at least a portion of a surface of the conductive substrate.

The present disclosure further provides a coated substrate comprising an electrodeposited binder comprising a reaction product of an active hydrogen-containing, ionic salt group-containing film-forming polymer and a curing agent; at least one organic resinous component different than the active hydrogen-containing, ionic salt group-containing film-forming polymer and curing agent, wherein the organic resinous component has an aliphatic content of at least 60% by weight, based on the total weight of the organic resinous component; a curing catalyst comprising a bismuth-containing curing catalyst, an amine-containing curing catalyst, a zinc-containing curing catalyst, a zirconium-containing catalyst, a cerium-containing catalyst, an amidine-containing catalyst, an imidazole-containing catalyst, and/or a titanium-containing catalyst; and calcined clay pigment.

The present disclosure further provides a use of the electrodepositable coating composition of the present disclosure for making a coating having at least one of: an elongation at break of at least 1.25%; a tensile toughness of at least 0.5 MPa; an electrodeposited binder comprising a first resin domain and a second resin domain; an electrodeposited binder comprising: a first resin domain having a first glass transition temperature; and a second resin domain having a second glass transition temperature, wherein the first glass transition temperature is at least 10 °C greater than the second glass transition temperature, and the second glass transition temperature is greater than −50 °C; and/or an electrodeposited binder comprising: a first resin domain having a first glass transition temperature of at least 80 °C; and a second resin domain having a second glass transition temperature of from −50 °C to 70 °C.

### DETAILED DESCRIPTION

The present disclosure is directed to an electrodepositable coating composition comprising an active hydrogen-containing, ionic salt group-containing film-forming polymer; a curing agent; at least one organic resinous component different than the active hydrogen-containing, ionic salt group-containing film-forming polymer and curing agent, wherein the organic resinous component has an aliphatic content of at least 60% by weight, based on the total weight of the organic resinous component, such as at least 65% by weight, such as at least 70% by weight, such as at least 75% by weight, such as at least 77% by weight, such as at least 80% by weight, such as at least 83% by weight, such as at least 86% by weight, such as at least 89% by weight, such as at least 92% by weight, such as at least 95% by weight; a curing catalyst substantially free, essentially free, or completely free of catalytic tin and/or comprising a bismuth-containing curing catalyst, an amine-containing curing catalyst, a zinc-containing curing catalyst, a zirconium-containing catalyst, a cerium-containing catalyst, an amidine-containing catalyst, an imidazole-containing catalyst, and/or a titanium-containing catalyst; and calcined clay pigment.

As used herein, the term “electrodepositable coating composition” refers to a composition that is capable of being deposited onto an electrically conductive substrate under the influence of an electrical potential applied between two electrodes immersed in the electrodepositable coating composition, where one of the electrodes is the substrate to be coated.

The electrodepositable coating composition comprises an electrodepositable binder that may comprise any suitable electrodepositable binder. The electrodepositable binder may comprise an organic and/or inorganic electrodepositable binder. As used here-in the term “binder” refers to the non-volatile content, excluding fillers, of the electrodepositable coating composition.

As used herein, the term “film forming polymer” is used interchangeably with “polymer” or “resin”, and refers to one or more polymers, such as homopolymers and/or copolymers, as well as prepolymers, oligomers, and monomers, that are capable of forming a film upon reaction with a curing agent or crosslinker. As used herein, the term “crosslinker”, “crosslinking agent”, or “curing agent” refers to a molecule capable of forming a covalent linkage between polymers. For example, a polyisocyanate curing agent may react with active hydrogen groups on a film-forming polymer to effectuate at least partial cure of the coating composition to form a coating. As used herein, the term “cure”, “cured” or similar terms, means that at least a portion of the coating composition is crosslinked to form a coating.

The electrodepositable coating composition comprises an ionic salt group-containing film-forming polymer, such as a cationic salt group containing film-forming polymer or an anionic salt group containing film-forming polymer.

The ionic salt group-containing film-forming polymer may comprise a reaction product of a reaction mixture comprising (a) a polyepoxide; (b) di-functional chain extender; and (c) a mono-functional reactant. Examples of such polymers are provided in Int'l App. No. PCT/US22/73356, at paragraphs [0023] to [0038], the cited portion of which is incorporated herein by reference.

As used herein, the term “cationic salt group-containing film-forming polymer” refers to polymers that include at least partially neutralized cationic salt groups, such as amine, sulfonium and/or ammonium salt groups, that impart a positive charge. The cationic salt group-containing film-forming polymer may comprise active hydrogen functional groups. As used herein, the term “active hydrogen functional groups” refers to those groups that are reactive with isocyanates, and include hydroxyl groups, primary or secondary amine groups, carbamate, and thiol groups.

Examples of polymers that are suitable for use as the cationic salt group-containing film-forming polymer of the electrodepositable composition include, but are not limited to, alkyd polymers, acrylics, polyepoxides, polyamides, polyurethanes, polyureas, polyethers, and polyesters, as well as adducts, derivatives and combinations thereof.

The cationic salt group-containing film-forming polymer is made cationic and water dispersible by at least partial neutralization with an acid such as formic acid, acetic acid, methanesulfonic acid, lactic acid, phosphoric acid and/or sulfamic acid.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium. For example, the amount of acid used may provide at least 20% of all of the total theoretical neutralization. Alternatively, the amount of acid used may provide in excess of 100% of all of the total theoretical neutralization. The total amount of acid used to neutralize the cationic salt group-containing film-forming polymer may range between any combination of values such as at 20% or more, to, such as greater than 100%, inclusive of the recited values. The total amount of acid used to neutralize the active hydrogen-containing, cationic salt group-containing film-forming polymer may be equal to or greater than 20%, 35%, 50%, 60%, 80%, or 100%, based on the total amines in the cationic salt group-containing film-forming polymer.

As used herein, the term “anionic salt group containing film-forming polymer” refers to an anionic polymer comprising at least partially neutralized anionic functional groups, such as carboxylic acid and/or phosphoric acid groups that impart a negative charge. The anionic salt group-containing film-forming polymer may comprise active hydrogen functional groups.

Examples of polymers that are suitable for use as the anionic salt group-containing film-forming polymer of the electrodepositable binder include, but are not limited to, drying and/or semi-drying, and/or saturated alkyd polymers, acrylics, polyepoxides, polyamides, polyurethanes, polyureas, polyethers, polyesters, resinous polyols, phosphatized polyepoxides, and phosphatized acrylic polymers, vehicles comprising alkyds and amine-aldehydes, as well as adducts, derivatives and combinations thereof.

Examples of inorganic electrodepositable film-forming polymers include silicone-based film-forming polymers. Examples of such silicone-based film-forming polymers are described in Int'l Pub. No. WO 2021/138384 A1, at paragraphs [0007] through [0029], the cited portion of which is incorporated herein by reference.

The active hydrogen-containing, ionic salt group-containing film-forming polymer may have an aromatic content of at least 10% by weight, based on the total weight of the active hydrogen-containing, ionic salt group-containing film-forming polymer, such as at least 15% by weight, such as at least 20% by weight, such as at least 25% by weight, such as at least 30% by weight, such as at least 35% by weight, such as at least 40% by weight.

As used herein, the term “aromatic content” refers to structures with pi bonds in resonance where the number of π electrons, according to molecular orbital theory, is equal to 4n+2, in which n=1, 2, 3, etc. An example of a cyclic aromatic structure is a benzene ring having six π electrons and n=1. The weight percent of aromatic content in a polymer is determined by including only the atoms within the aromatic structure, e.g., for a benzene ring, only the six carbon atoms in the ring contribute to the aromatic content of the polymer.

The ionic salt group-containing film-forming polymer may be present in the electrodepositable coating composition in an amount of at least 40% by weight, such as at least 50% by weight, such as at least 55% by weight, such as at least 60% by weight, based on the total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on the total weight of the resin solids of the electrodepositable coating composition. The ionic salt group-containing film-forming polymer may be present in the electrodepositable coating composition, in an amount of 40% to 90% by weight, such as 40% to 80% by weight, such as 40% to 75% by weight, such as 50% to 90% by weight, such as 50% to 80% by weight, such as 50% to 75% by weight, such as 55% to 90% by weight, such as 55% to 80% by weight, such as 55% to 75% by weight, such as 60% to 90% by weight, such as 60% to 80% by weight, such as 60% to 75% by weight, based on the total weight of the resin solids of the electrodepositable coating composition.

As used herein, the “resin solids” include the ionic salt group-containing film-forming polymer, the curing agent, and any additional water-dispersible non-pigmented component(s) present in the electrodepositable coating composition.

The electrodepositable coating composition of the present disclosure may further comprise a curing agent. The curing agent may react with the reactive groups, such as active hydrogen groups, of the ionic salt group-containing film-forming polymer as well as any reactive groups, if present, of any additional resinous materials, to effectuate cure of the electrodepositable coating composition to form a coating. Examples of suitable curing agents include at least partially blocked polyisocyanates, as well as aminoplast resins, and/or phenoplast resins, such as phenolformaldehyde condensates including allyl ether derivatives thereof.

As used herein, a “blocked polyisocyanate” means a polyisocyanate wherein at least a portion of the isocyanato groups is blocked by a blocking group introduced by the reaction of a free isocyanato group of the polyisocyanate with a blocking agent. By “blocked” is meant that the isocyanato groups have been reacted with a blocking agent such that the resultant blocked isocyanate group is stable to active hydrogens at ambient temperature, e.g., room temperature (23 °C). The reaction may be reversed under suitable conditions, such as at elevated temperatures, such as, e.g., between 90 °C and 200 °C, such that the previously blocked isocyanato groups on the polyisocyanate curing agent are unblocked and available to react with the reactive groups, such as active hydrogen groups, of the ionic salt group-containing film-forming polymer to effectuate cure of the coating composition to form a coating.

As used herein, a “blocking agent” refers to a compound comprising a functional group reactive with an isocyanato group resulting in a blocked isocyanate. As used herein, a “blocking group” refers to the bound residual moiety of a blocking agent to the isocyanato group in the blocked polyisocyanate.

Blocking agents that are disassociated from the blocked polyisocyanate curing agent during cure may be removed from the coating film by volatilization. Alternatively, a portion or all of the blocking agent may remain in the coating film following cure.

Examples of blocked polyisocyanates curing agents, and amounts thereof, including suitable polyisocyanates, and blocking components such as blocking groups and/or blocking agents, such as but not limited to 1,2 polyols, are provided in Int'l Pub. No. WO 2021/138583 A1, at paragraphs [0022] to [0035], the cited portion of which is incorporated herein by reference.

Examples of blocked polyisocyanates comprising a blocking group derived from a blocking agent comprising an alpha-hydroxy amide, ester, or thioester and, optionally, a second blocking agent, are provided in Int'l Pub. No. WO 2018/148306 A1, at paragraphs [0010] to [0029], the cited portion of which is incorporated herein by reference. The blocked polyisocyanate may be a fully blocked polyisocyanate wherein essentially 100% of the isocyanato groups of the polyisocyanate are blocked with one or more blocking groups. Optionally, the blocked polyisocyanate curing agent may be an at least partially blocked polyisocyanate, having fewer than 100% of the isocyanato groups blocked, as long as the coating composition remains a stable dispersion. The term “stable dispersion” refers to a dispersion that does not settle or is easily re-dispersible if some settling occurs.

The at least partially blocked polyisocyanate may be partially blocked with one or more of the blocking groups discussed above with the remaining isocyanato groups reacted with the polymer backbone, such as described in U.S. Pat. No. 3,947,338, at col. 2, line 65 through col. 5, line 33, the cited portion of which is herein incorporated by reference.

The blocked polyisocyanate curing agent may comprise a tris(alkoxycarbonylamino)-1,3,5-triazine (TACT). Examples of suitable tris(alkoxycarbonylamino)-1,3,5-triazines include tris(methoxycarbonylamino)-, tris(butoxycarbonylamino)-, and tris(2-ethylhexoxycarbonylamino)-1,3,5-triazines, and any combination thereof.

The curing agent may comprise an aminoplast or a phenoplast resin. Aminoplast resins are condensation products of an aldehyde with an amino- or amido-group carrying substance. Phenoplast resins are formed by the condensation of an aldehyde and a phenol.

Examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins, and amounts thereof, also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Suitable aminoplast and phenoplast resins also are described in U.S. Pat. No. 4,812,215 at col. 6, line 20 to col. 7, line 12, the cited portion of which being incorporated herein by reference.

Silicone-based curing agents may also be used. Examples of such curing agents are described in Int'l Pub. No. WO 2021/138384 A1, at paragraphs [0030] through [0043], the cited portion of which is incorporated herein by reference.

The curing agent may be present in the electrodepositable coating composition, in an amount of at least 10% by weight, such as at least 20% by weight, such as at least 25% by weight, based on the total weight of the resin solids of the electrodepositable coating composition. The curing agent may be present in the electrodepositable coating composition, in an amount of no more than 60% by weight, such as no more than 50% by weight, such as no more than 45% by weight, such as no more than 40% by weight, based on the total weight of the resin solids of the electrodepositable coating composition. The curing agent may be present in the electrodepositable coating composition, in an amount of 10% to 60% by weight, such as 10% to 50% by weight, such as 10% to 45% by weight, such as 10% to 40% by weight, such as 20% to 60% by weight, such as 20% to 50% by weight, such as 20% to 45% by weight, such as 20% to 40% by weight, such as 25% to 60% by weight, such as 25% to 50% by weight, such as 25% to 45% by weight, such as 25% to 40% by weight, based on the total weight of the resin solids of the electrodepositable coating composition.

The electrodepositable coating composition further comprises at least one organic resinous component different than the primary components of the electrodepositable binder, including the active hydrogen-containing, ionic salt group-containing film-forming polymer and curing agent.

As used herein, “organic resinous component” refers to an organic-based polymeric component.

The organic resinous component has an aliphatic content of at least 60% by weight, based on the total weight of the organic resinous component, such as at least 65% by weight, such as at least 70% by weight, such as at least 75% by weight, such as at least 77% by weight, such as at least 80% by weight, such as at least 83% by weight, such as at least 86% by weight, such as at least 89% by weight, such as at least 92% by weight, such as at least 95% by weight.

As used herein, the term “aliphatic content” refers to any organic chemical constituent in which the atoms are connected by single, double, or triple bonds to form non-aromatic structures. The aliphatic content of a resin may be determined based on the mass of the atoms comprising aromatic structures in a polymer, i.e., the aromatic content, as defined above, and the total mass of the polymer, according to the following equation:

$$\% Aliphatic Content = \frac{Total mass of polymer - Mass of atoms in aromatic structures}{Total mass of polymer} \times 100$$

The aliphatic portion of the organic resinous component is not limited and may comprise a polyether; a polyalkylene glycol; a poly(alkyl-1,2-diol); polyethylene oxide; polypropylene oxide; polybutylene oxide; polytetrahydrofuran; a polyurethane; a polyester; an addition polymer; a (meth)acrylic oligomer or polymer; a vinyl oligomer or polymer; and/or an aliphatic compound having two or more epoxide functional groups reacted with an aliphatic compound having one or more amine functional groups.

The organic resinous component may comprise a polyetheramine-adduct, an acrylic polymer, a polyester, a urethane, and/or a polyurethane.

The organic resinous component may comprise one or more functional groups, such as, an active hydrogen functional group including an amine functional group. The organic resinous component may also comprise cationic and/or cationic salt groups.

The organic resinous component may have a glass transition temperature of <0 °C, such as <−5 °C, such as <−10 °C, such as <−20 °C, such as <−25 °C, such as <−30 °C.

The organic resinous component may have a hydroxyl value of <130 mg KOH/g organic resinous component, such as <125 mg KOH/g organic resinous component, such as <120 mg KOH/g organic resinous component. As used herein, the term “hydroxyl value” refers to the number of milligrams of potassium hydroxide (KOH) required to neutralize the acetic acid taken up on acetylation of one gram of a chemical substance that contains free hydroxyl groups and was herein determined by a theoretical calculation of the number of free hydroxyl groups theoretically present in one gram of the organic resinous component.

The organic resinous component may have a z-average molecular weight (Mz) of at least 10,000 g/mol, such as at least 15,000 g/mol, such as at least 20,000 g/mol, such as at least 25,000 g/mol, such as at least 30,000 g/mol.

The organic resinous component may have a weight average molecular weight (M_{w}) of at least 5,000 g/mol, such as at least 7,500 g/mol, such as at least 10,000 g/mol, such as at least 12,500 g/mol, such as at least 15,000 g/mol.

As used herein, unless otherwise stated, the term “weight average molecular weight (M_{w})” means the weight average molecular weight (M_{w}) as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

The organic resinous component may have a number average molecular weight (Mₙ) of at least 2,000 g/mol, such as at least 2,250 g/mol, such as at least 2,500 g/mol, such as at least 2,750 g/mol, such as at least 3,000 g/mol, such as at least 5,000 g/mol, such as at least 7,000 g/mol.

As used herein, unless otherwise stated, the term “number average molecular weight (Mₙ)” means the number average molecular weight (Mₙ) as determined by Gel Permeation Chromatography using a Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

As noted above, the organic resinous component may comprise a polyetheramine-adduct. The polyetheramine-adduct may comprise an ungelled ionic reaction product prepared from reactants comprising: (a) a reaction product prepared from reactants comprising: (1) a di-functional chain extender; and (2) an epoxy functional material; and (b) a polyetheramine.

The di-functional chain extender may comprise any suitable di-functional chain extender. For example, the di-functional chain extender may comprise a di-hydroxyl functional reactant, a di-carboxylic acid functional reactant, or a primary amine functional reactant. The di-hydroxyl functional reactant may comprise a bisphenol such as bisphenol A and/or bisphenol F, resorcinol, dihydroxy benzene, aliphatic, cycloaliphatic or aralaphatic hydroxyl containing compounds, such as ethylene glycol, propylene glycol, dihydroxyl cyclohexane, dimethylol cyclohexane, or combinations thereof. The di-carboxylic acid functional reactant may comprise a dimer fatty acid, terephthalic acid, adipic acid, or combinations thereof. The primary amine functional reactant may comprise ethanolamine, aminopropyldiethanolamine (APDEA), dimethylaminopropylamine (DMAPA), 2-ethylhexylamine, or combinations thereof. The di-functional chain extender may be present in the polyetheramine-adduct in an amount of 0% to 20% by weight based on the total weight of the reactants that form the polyetheramine-adduct reaction product, such as 0% to 15% by weight, such as 1% to 20% by weight, such as 1% to 15% by weight.

Examples of suitable epoxy-functional materials useful for forming the ungelled ionic reaction product contain at least one epoxy group in the molecule, such as di- or polyglycidyl ethers of polyhydric alcohols, such as a polyglycidyl ether of bisphenol A. Suitable epoxy-functional materials may have an epoxy equivalent weight ranging from 90 to 2000, as measured by titration with perchloric acid using methyl violet as an indicator. The epoxy-functional material may comprise 10% to 40% by weight based on the total weight of the epoxy functional polyester, such as 15% to 35% by weight of the epoxy functional material is combined or reacted with the polyester described above to form the epoxy functional polyester.

According to the present disclosure, the polyetheramine may be characterized by propylene oxide, ethylene oxide, tetrahydrofuran, or mixed propylene oxide, ethylene oxide, and/or tetrahydrofuran (e.g., poly(tetrahydrofuran)) repeating units in their respective structures, such as one of the Jeffamine series products (commercially available from Huntsman Corporation). Examples of such polyetheramines include aminated propoxylated pentaerythritols, such as Jeffamine XTJ-616, and those represented by Formulas (I) through (III).

According to Formula (I) of the present disclosure the polyetheramine may comprise or represent:

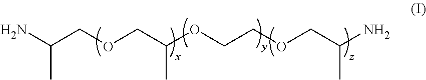

wherein y=0-39, x+z=1-68.

Suitable polyetheramines represented by Formula (I) include, but are not limited to, amine-terminated polyethylene glycol such as Huntsman Corporation Jeffamine ED series, such as Jeffamine ED-600, Jeffamine ED-900 and Jeffamine ED-2003, and amine-terminated polypropylene glycol such as Huntsman Corporation Jeffamine D series, such as Jeffamine D-230, Jeffamine D-400, Jeffamine D-2000 and Jeffamine D-4000, and amine-terminated diethylene glycol grafted with propylene oxide, such as Huntsman Corporation Jeffamine HK-511.

According to Formula (II) of the present disclosure the polyetheramine may comprise or represent:

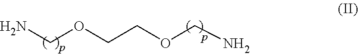

wherein each p independently is 2 or 3.

Suitable polyetheramines represented by Formula (II) include, but are not limited to, amine-terminated polyethylene glycol-based diamine, such as Huntsman Corporation Jeffamine EDR series, such as Jeffamine EDR-148 and Jeffamine EDR-176.

According to Formula (III) of the present disclosure the polyetheramine may comprise or represent:

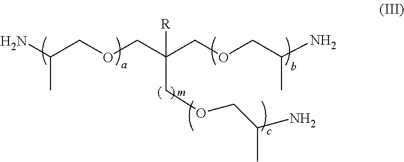

wherein R is H or C₂H₅, m=0 or 1, a+b+c=5-85.

Suitable polyetheramines represented by Formula (III) include, but are not limited to, amine-terminated propoxylated trimethylolpropane or glycerol, such as Huntsman Corporation Jeffamine T series, such as Jeffamine T-403, Jeffamine T-3000 and Jeffamine T-5000.

The z-average molecular weight (M_{z}) of the polyetheramine may be at least 200 g/mol, such as at least 400 g/mol, such as at least 1,000 g/mol, such as at least 5,000 g/mol, such as at least 7,000 g/mol, such as at least 10,000 g/mol, and may be no more than 300,000 g/mol, such as no more than 100,000 g/mol, such as no more than 15,000 g/mol. The molecular weight of the polyetheramine may be 200 g/mol, to 300,000 g/mol, such as 400 g/mol to 300,000 g/mol, such as 1,000 g/mol to 300,000 g/mol, such as 5,000 g/mol to 300,000 g/mol, such as 7,000 g/mol to 100,000 g/mol, such as 10,000 g/mol to 15,000 g/mol. As used herein, with respect to polymers having a z-average molecular weight (M_{z}) of less than 900,000, the term “z-average molecular weight (M_{z})” means the z-average molecular weight (M_{z}) as determined by Gel Permeation Chromatography using Waters 2695 separation module with a Waters 410 differential refractometer (RI detector), polystyrene standards having molecular weights of from approximately 500 g/mol to 900,000 g/mol, tetrahydrofuran (THF) with lithium bromide (LiBr) as the eluent at a flow rate of 0.5 mL/min, and one Asahipak GF-510 HQ column for separation. With respect to polymers having a z-average molecular weight (M_{z}) of greater than 900,000 g/mol, the term “z-average molecular weight (M_{z})” means the theoretical z-average molecular weight (M_{z}) as determined by Gel Permeation Chromatography (“GPC”) using Waters 2695 separation module with a Waters 410 differential refractometer (RI detector), polystyrene standards having molecular weights of from approximately 500 g/mol to 3,000,000 g/mol, tetrahydrofuran (THF) with lithium bromide (LiBr) as the eluent at a flow rate of 0.5 mL/min, and one Asahipak GF-7M HQ column for separation.

The amine equivalent weight of the polyetheramine may be at least 200 g/amine, such as at least 400 g/amine, such as at least 450 g/amine, and may be no more than 5,000 g/amine, such as no more than 2,000 g/amine, such as no more than 600 g/amine. The amine equivalent weight may be from 200 g/amine to 5,000 g/amine, such as 400 g/amine to 2,000 g/amine, such as 450 g/amine to 600 g/amine. As used herein, the “amine equivalent weight” is determined by dividing the molecular weight of the amine-containing compound by the number of amino groups present in the polymer.

Further examples of the polyetheramine-adduct are those described in U.S. Pat. No. 4,420,574 at col. 2, line 54 through col. 5, line 34, and U.S. Pat. No. 4,423,166 at col. 4, line 44 through col. 5, line 25, the cited portions of which are incorporated herein by reference.

The polyetheramine adduct may have a weight average molecular weight of at least 10,000 g/mol, such as at least 30,000 g/mol, such as at least 50,000 g/mol, such as at least 75,000 g/mol, such as such as at least 100,000 g/mol, such as at least 125,000 g/mol. The polyetheramine adduct may have a weight average molecular weight of no more than 500,000 g/mol, such as no more than 400,000 g/mol, such as no more than 300,000 g/mol, such as no more than 250,000 g/mol, such as no more than 200,000 g/mol, such as no more than 150,000 g/mol. The polyetheramine adduct may have a weight average molecular weight of 10,000 to 500,000 g/mol, such as 10,000 to 400,000 g/mol, such as 10,000 to 300,000 g/mol, such as 10,000 to 250,000 g/mol, such as 10,000 to 200,000 g/mol, such as 10,000 to 150,000 g/mol, such as 30,000 to 500,000 g/mol, such as 30,000 to 400,000 g/mol, such as 30,000 to 300,000 g/mol, such as 30,000 to 250,000 g/mol, such as 30,000 to 200,000 g/mol, such as 30,000 to 150,000 g/mol, such as 50,000 to 500,000 g/mol, such as 50,000 to 400,000 g/mol, such as 50,000 to 300,000 g/mol, such as 50,000 to 250,000 g/mol, such as 50,000 to 200,000 g/mol, such as 50,000 to 150,000 g/mol, such as 75,000 to 500,000 g/mol, such as 75,000 to 400,000 g/mol, such as 75,000 to 300,000 g/mol, such as 75,000 to 250,000 g/mol, such as 75,000 to 200,000 g/mol, such as 75,000 to 150,000 g/mol, such as 100,000 to 500,000 g/mol, such as 100,000 to 400,000 g/mol, such as 100,000 to 300,000 g/mol, such as 100,000 to 250,000 g/mol, such as 100,000 to 200,000 g/mol, such as 100,000 to 150,000 g/mol, such as 125,000 to 500,000 g/mol, such as 125,000 to 400,000 g/mol, such as 125,000 to 300,000 g/mol, such as 125,000 to 250,000 g/mol, such as 125,000 to 200,000 g/mol, such as 125,000 to 150,000 g/mol.

The polyetheramine adduct may have a polyethylene oxide, polypropylene oxide, polybutylene oxide, or a combination thereof, content of at least 60% by weight, based on the total weight of the polyetheramine adduct, such as at least 70% by weight, such as at least 80% by weight, such as at least 90% by weight.

The electrodepositable coating composition may comprise one or more different polyetheramine-adducts.

The organic resinous component may be present in the electrodepositable coating and/or electrodepositable coating composition in an amount of at least 3% by weight based on the total weight of the electrodepositable binder, such as at least 5% by weight, such as at least 10% by weight, such as at least 15% by weight, such as at least 20% by weight, such as at least 25% by weight. The organic resinous component may be present in the electrodepositable coating and/or electrodepositable coating composition in an amount of no more than 35% by weight, such as no more than 30% by weight based on the total weight of the electrodepositable binder, such as no more than 25% by weight, such as no more than 20% by weight, such as no more than 15% by weight, such as no more than 10% by weight, such as no more than 5% by weight. The organic resinous component may be present in the electrodepositable coating and/or electrodepositable coating composition in an amount of 3% to 35% by weight, such as 3% to 30% by weight, such as 3% to 25% by weight, such as 3% to 20% by weight, such as 3% to 15% by weight, such as 3% to 10% by weight, such as 3% to 5% by weight, such as 5% to 35% by weight, such as 5% to 30% by weight, such as 5% to 25% by weight, such as 5% to 20% by weight, such as 5% to 15% by weight, such as 5% to 10% by weight, such as 10% to 35% by weight, such as 10% to 30% by weight, such as 10% to 25% by weight, such as 10% to 20% by weight, such as 10% to 15% by weight, such as 15% to 35% by weight, such as 15% to 30% by weight, such as 15% to 25% by weight, such as 15% to 20% by weight, such as 20% to 35% by weight, such as 20% to 30% by weight, such as 20% to 25% by weight, such as 25% to 35% by weight, such as 25% to 30% by weight, based on the total weight of the electrodepositable binder.

The electrodepositable coating composition further comprises a curing catalyst. As used herein, the term “curing catalyst” is used interchangeably with “catalyst” and refers to materials that catalyze the curing reaction between components of the electrodepositable coating composition, such as the curing agent and film-forming polymers. For example, the catalyst may catalyze transurethanation reactions, and specifically catalyze the deblocking of blocked polyisocyanate blocking groups.

Examples of curing catalysts include amine-containing compounds; compounds or complexes of metals such as bismuth, cerium, zirconium, zinc, and/or titanium; and combinations thereof.

Catalysts suitable for cationic electrodepositable coating compositions include, without limitation, metal oxides (e.g., oxides of cerium, zirconium and bismuth) and salts thereof; zinc compounds or complexes; and/or a cyclic guanidine as described in U.S. Pat. No. 7,842,762 at col. 1, line 53 to col. 4, line 18 and col. 16, line 62 to col. 19, line 8, the cited portions of which being incorporated herein by reference.

Catalysts suitable for anionic electrodepositable coating compositions include, without limitation, latent acid catalysts. Latent acid catalysts are derivatives of acid catalysts that are generally activated by heating. Examples of latent acid catalysts are identified in WO 2007/118024 at paragraph [0031]. Further examples of suitable latent acid catalysts include derivatives of acid catalysts such as sulfonic acids, such as derivatives of para-toluenesulfonic acid, such as pyridinium para-toluenesulfonate.

The amine-containing curing catalyst may comprise any suitable amine-containing curing catalyst, such as, but not limited to, curing catalysts comprising a guanidine, an imidazole, an amidine, and/or derivatives or combinations thereof.

Examples of suitable guanidine curing catalysts are provided in Int'l Pub. No. WO 2018/0172519 A1, at paragraphs [0039] to [0050], the cited portion of which is incorporated herein by reference.

Examples of imidazole curing catalysts are described in U.S. Pub. No. 2022/0154014 A1, as paragraphs [0062] to [0108], the cited portion of which is incorporated herein by reference.

The amidine curing catalyst may comprise 1,8-diazabicyclo[5.4.0]undec-7-ene (DBU).

The zinc-containing catalyst may comprise a metal salt and/or complex of zinc such as, but not limited to, a zinc (II) amidine complex, zinc octoate, zinc naphthenate, zinc tallate, zinc carboxylates having from 8 to 14 carbons in the carboxylate group, zinc acetate, zinc sulfonates, zinc methanesulfonates, or any combination thereof. The zinc (II) amidine complex may contain amidine and carboxylate ligands.

The curing catalyst may be present in the electrodepositable coating composition in any suitable amount. The amine and/or the zinc-containing curing catalyst may each individually be present in the coating composition in an amount of at least 0.1% by weight, based on the total weight of the resin solids of the coating composition, such as at least 0.2% by weight, such as at least 0.5% by weight, such as at least 0.8% by weight, such as at least 1% by weight, such as at least 1.5% by weight. The amine and/or zinc-containing curing catalyst may each individually be present in the coating composition in an amount of no more than 7% by weight, based on the total weight of the resin solids of the coating composition, such as no more than 4% by weight, such as no more than 2% by weight, such as no more than 1.5% by weight, such as no more than 1% by weight. The amine and/or zinc-containing curing catalyst may each individually be present in the coating composition in an amount of 0.1% to 7% by weight, based on the total weight of the resin solids of the coating composition, such as 0.1% to 4% by weight, such as 0.1% to 2% by weight, such as 0.1% to 1.5% by weight, such as 0.1% to 1% by weight, such as 0.2% to 7% by weight, such as 0.2% to 4% by weight, such as 0.2% to 2% by weight, such as 0.2% to 1.5% by weight, such as 0.2% to 1% by weight, such as 0.5% to 7% by weight, such as 0.5% to 4% by weight, such as 0.5% to 2% by weight, such as 0.5% to 1.5% by weight, such as 0.5% to 1% by weight, such as 0.8% to 7% by weight, such as 0.8% to 4% by weight, such as 0.8% to 2% by weight, such as 0.8% to 1.5% by weight, such as 0.8% to 1% by weight, such as 1% to 7% by weight, such as 1% to 4% by weight, such as 1% to 2% by weight, such as 1% to 1.5% by weight, such as 1.5% to 7% by weight, such as 1.5% to 4% by weight, such as 1.5% to 2% by weight.

The curing catalyst may comprise a bismuth catalyst.

The bismuth catalyst may comprise a soluble bismuth catalyst. As used herein, a “soluble” or “solubilized” bismuth catalyst is at catalyst wherein at least a portion of the bismuth metal from the bismuth catalyst is dissolved in the aqueous medium of the electrodepositable coating composition, such as at least 5% by weight of bismuth metal from the bismuth catalyst is dissolved based on the total weight of the bismuth metal from the bismuth catalyst, such as at least 10% by weight, such as at least 20% by weight, such as at least 30% by weight, such as at least 35% by weight, such as at least 40% by weight, such as at least 45% by weight, such as at least 50% by weight. The percentage of solubilized bismuth present in the electrodepositable coating composition may be determined using ICP-OES to calculate the total amount of bismuth (i.e., solubilized and non-solubilized) and total amount of solubilized bismuth and calculating the percentage using those measurements. The soluble bismuth catalyst may be at least partially pre-dissolved prior to addition to the electrodepositable coating composition or dissolved in situ in the electrodepositable coating composition.

Alternatively, the bismuth catalyst may comprise an insoluble bismuth catalyst. As used herein, an “insoluble” bismuth catalyst is at bismuth catalyst wherein less than 5% of bismuth metal from the bismuth catalyst is dissolved in the aqueous medium of the electrodepositable coating composition, such as less than 3% by weight of bismuth metal from the bismuth catalyst is dissolved based on the total weight of the bismuth metal from the bismuth catalyst.

The bismuth catalyst may be present in an amount such that the amount of solubilized bismuth metal may be at least 0.005% by weight, based on the total weight of the electrodepositable coating composition, such as at least 0.01% by weight, such as at least 0.04% by weight, such as at least 0.06% by weight, such as at least 0.07% by weight, such as at least 0.08% by weight, such as at least 0.09% by weight, such as at least 0.10% by weight, such as at least 0.11% by weight, such as at least 0.12% by weight, such as at least 0.13% by weight, such as at least 0.14% by weight, or higher.

The bismuth catalyst may be present in an amount such that the amount of solubilized bismuth metal may be at least 0.05% by weight, at least 0.22% by weight, based on the total weight of the resin solids, such as at least 0.01% by weight, such as at least 0.22% by weight, such as at least 0.30% by weight, such as at least 0.34% by weight, such at least 0.40% by weight, such as at least 0.45% by weight, such as 0.51% by weight, such as at least 0.56% by weight, such as at least 0.62% by weight, such as at least 0.68% by weight, such as at least 0.73% by weight, such as at least 0.80% by weight, or higher.

The total amount of bismuth metal introduced into the composition from the bismuth catalyst is not limited but may be up to 30,000 ppm or higher. The composition may include at least 10 ppm soluble bismuth metal, such as at least 100 ppm soluble bismuth metal, such as at least 150 ppm soluble bismuth metal, such as at least 200 ppm soluble bismuth metal, such as at least 300 ppm soluble bismuth metal, such as at least 500 ppm soluble bismuth metal, such as at least 1,000 ppm soluble bismuth metal, such as at least 3,000 ppm soluble bismuth metal, such as at least 5,000 ppm soluble bismuth metal, such as at least 10,000 ppm soluble bismuth metal, such as at least 15,000 ppm soluble bismuth metal. The composition may include no more than 20,000 ppm soluble bismuth metal, such as no more than 15,000 ppm soluble bismuth metal, such as no more than 10,000 ppm soluble bismuth metal, such as no more than 5,000 ppm soluble bismuth metal, such as no more than 3,000 ppm soluble bismuth metal, such as no more than 1,000 ppm soluble bismuth metal, such as no more than 800 ppm soluble bismuth metal, such as no more than 600 ppm soluble bismuth metal, such as no more than 500 ppm, such as no more than 400 ppm. The composition may include 10 to 20,000 ppm soluble bismuth metal, such as 100 to 20,000 ppm soluble bismuth metal, such as 150 to 15,000 ppm soluble bismuth metal, such as 200 to 10,000 ppm soluble bismuth metal, such as 300 to 5,000 ppm soluble bismuth metal, such as 500 to 3,000 ppm soluble bismuth metal, such as 10 to 1,000 ppm soluble bismuth metal, such as 100 to 1,000 ppm soluble bismuth metal, such as 100 to 800 ppm soluble bismuth metal, such as 100 to 600 ppm soluble bismuth metal, such as 100 to 500 ppm soluble bismuth metal, such as 100 to 400 ppm soluble bismuth metal, such as 150 to 1,000 ppm soluble bismuth metal soluble bismuth metal, such as 150 to 800 ppm soluble bismuth metal, such as 150 to 600 ppm soluble bismuth metal, such as 150 to 500 ppm soluble bismuth metal, such as 150 to 400 ppm soluble bismuth metal.

The bismuth catalyst may comprise a bismuth compound and/or complex.

The bismuth catalyst may comprise a colloidal bismuth oxide or bismuth hydroxide, a bismuth compound complex such as a bismuth chelate complex, or a bismuth salt of an inorganic or organic acid, wherein the term “bismuth salt” includes not only salts comprising bismuth cations and acid anions, but also bismuthoxy salts.

Examples of inorganic or organic acids from which the bismuth salts may be derived are hydrochloric acid, nitric acid, sulphuric acid, inorganic or organic sulphonic acids, carboxylic acids, such as formic acid or acetic acid, amino carboxylic acids and hydroxy carboxylic acids, such as lactic acid or dimethylolpropionic acid.

Suitable bismuth salts include aliphatic hydroxycarboxylic acid salts of bismuth, such as lactic acid salts or dimethylolpropionic acid salts of bismuth, such as bismuth lactate or bismuth dimethylolpropionate; amidosulphonic acid salts of bismuth; hydrocarbylsulphonic acid salts of bismuth, such as alkyl sulphonic acid salts, including methane sulphonic acid salts of bismuth, such as bismuth methane sulphonate, bismuth ethane sulphonate, as well as combinations thereof. Further examples of bismuth compound or complex catalysts include bismuth oxides, bismuth carboxylates, bismuth subnitrate, bismuth sulfamate, bismuth sulphonate, and combinations thereof.

The bismuth catalyst may be a bismuth catalyst that is not a bismuth compound having a ligand prepared from a β-diketone. The electrodepositable coating composition may be substantially free, essentially free, or completely free of a bismuth compound having a ligand prepared from a β-diketone. As used herein, an electrodepositable coating composition is “substantially free” or “essentially free” of a bismuth compound having a ligand prepared from a β-diketone if such compound is present, if at all, in an amount of less than 0.1% by weight or less than 0.01% by weight, respectively, based on resin solids weight. As used herein, an electrodepositable coating composition is “completely free” of a bismuth compound having a ligand prepared from a β-diketone if such compound is not present, i.e., 0.00% by weight, based on resin solids weight.

The bismuth catalyst may be present in an amount of at least 0.01% by weight of bismuth metal, such as at least 0.1% by weight, such as at least 0.2% by weight, such as at least 0.5% by weight, such as at least 1% by weight, such as 1% by weight, based on the total resin solids weight of the composition. The bismuth catalyst may be present in an amount of no more than 3% by weight of bismuth metal, such as no more than 1.5% by weight, such as no more than 1% by weight, based on the total resin solids weight of the composition. The bismuth catalyst may be present in an amount of 0.01% to 3% by weight of bismuth metal, such as 0.1% to 1.5% by weight, such as 0.2% to 1% by weight, such as 0.5% to 3% by weight, such as 0.5% to 1.5% by weight, such as 0.5% to 1% by weight, such as 1% to 3% by weight, such as 1% to 1.5% by weight, based on the total resin solids weight of the composition.

The curing catalyst may comprise a titanium compound and/or complex such as Ti(OR¹)₄, wherein R¹ is an alkyl or aryl, such as wherein R¹ is a C3-C20 alkyl, such as wherein R¹ is n-butyl, such as tetrabutyl titanate.

The electrodepositable coating composition may be substantially free, essentially free, or completely free of catalytic tin. The electrodepositable coating composition may be substantially free, essentially free, or completely free of catalytic tin. As used herein, the electrodepositable coating composition is “substantially free” of catalytic tin if catalytic tin is present in an amount of less than 0.1% by weight, based on the total weight of the electrodepositable coating composition. As used herein, the electrodepositable coating composition is “essentially free” of catalytic tin if catalytic tin is present in an amount of less than 0.01%, based on the total weight of the electrodepositable coating composition. As used herein, the electrodepositable coating composition is “completely free” of catalytic tin if catalytic tin is present in an amount of 0.001%, based on the total weight of the electrodepositable coating composition.

The electrodepositable coating composition further comprises calcined clay pigment.

As used herein, “calcined clay” refers to metakaolin that is generally produced from heating kaolinite to an elevated temperature, such as 650 °C to 750 °C or higher. Calcined clay has a reduced water content relative to the non-calcined clay, as well as a harder surface, a reduced Brunauer-Emmett-Teller (BET) surface area, and higher oil adsorption.

The calcined clay may have a Mohs hardness of greater than 2.5, such as at least 2.8, such as at least 3.0.

The calcined clay may have an oil absorption of greater than 10 mL per 100 g, such as at least 20 mL per 100 g, such as at least 30 mL per 100 g, such as at least 40 mL per 100 g, such as at least 50 mL per 100 g, such as at least 60 mL per 100 g, such as at least 70 mL per 100 g, such as at least 80 mL per 100 g. The oil absorption values may be determined according to ASTM D6854-12a (2014) with a C.W. Brabender Absorptometer-C using di-octyl adipate. The standard speed setting during testing is approximately 125 rpm. The standard temperature reading during mixing is 23 °C. The burette setting is 4 mL/min. An endpoint at 70% maximum torque is used for the evaluation, applying moisture correction in the calculation. The results are reported as “mL per 100 g”.

The calcined clay may have a BET surface area of less than 19 m²/g, such as less than 17 m²/g, such as less than 15 m²/g, such as less than 13 m²/g. The BET surface area may be determined in accordance with the Brunauer-Emmet-Teller (BET) method in accordance with ASTM D1993-03, where the BET surface area is determined by fitting five relative-pressure points from a nitrogen sorption isotherm measurement made with a Micromeritics TriStar II Plus™ instrument. A flow Prep060™ station provided heat and a continuous gas flow to prepare samples for analysis. Prior to nitrogen sorption, the silica samples were dried by heating to a temperature of 160 °C in flowing nitrogen (P5 grade) for at least one (I) hour.

The calcined clay may have a median stokes equivalent particle diameter of at least 0.05 microns, such as at least 0.1 microns, such as at least 0.4 microns, such as at least 0.6 microns. The calcined clay may have a median stokes equivalent particle diameter of no more than 10 microns or higher, such as no more than 5 microns, such as no more than 3 microns, such as no more than 2 microns. The calcined clay may have a median stokes equivalent particle diameter of 0.05 to 10 microns, such as 0.05 to 5 microns, such as 0.05 to 3 microns, such as 0.05 to 2 microns, such as 0.1 to 10 microns, such as 0.1 to 5 microns, such as 0.1 to 3 microns, such as 0.1 to 2 microns, such as 0.4 to 10 microns, such as 0.4 to 5 microns, such as 0.4 to 3 microns, such as 0.4 to 2 microns, such as 0.6 to 10 microns, such as 0.6 to 5 microns, such as 0.6 to 3 microns, such as 0.6 to 2 microns. The median stokes equivalent particle diameter may be measured according to ISO 13318-1:2001.

The calcined clay pigment may have a particle size measured along a shortest axis of the particle of at least 0.05 microns, such as at least 0.1 microns, such as at least 0.4 microns, such as at least 0.6 microns. The calcined clay pigment may have a particle size measured along a shortest axis of the particle of no more than 10 microns or higher, such as no more than 5 microns, such as no more than 3 microns, such as no more than 2 microns. The calcined clay pigment may have a particle size measured along a shortest axis of the particle of 0.05 to 10 microns, such as 0.05 to 5 microns, such as 0.05 to 3 microns, such as 0.05 to 2 microns, such as 0.1 to 10 microns, such as 0.1 to 5 microns, such as 0.1 to 3 microns, such as 0.1 to 2 microns, such as 0.4 to 10 microns, such as 0.4 to 5 microns, such as 0.4 to 3 microns, such as 0.4 to 2 microns, such as 0.6 to 10 microns, such as 0.6 to 5 microns, such as 0.6 to 3 microns, such as 0.6 to 2 microns. As used herein, the particle size may be determined by visually examining a micrograph of a transmission electron microscopy (“TEM”) image of the particle, measuring the diameter of the particles in the image along various axis, and determining the shortest axis based on magnification of the TEM image. One of ordinary skill in the art will understand how to prepare such a TEM image and determine the particle size based on the magnification.

The pigment-to-binder (P:B) ratio as set forth in this disclosure refers to the weight ratio of the pigment-to-binder in the electrodepositable coating composition. The pigment-to-binder (P:B) ratio of the calcined clay pigment to the electrodepositable binder may be at least 0.01:1, such as at least 0.04:1, such as at least 0.06:1, such as at least 0.09:1, such as at least 0.1:1, such as at least 0.15:1, such as at least 0.2:1, such as at least 0.3:1, such as at least 0.4:1, such as at least 0.6:1, such as at least 0.8:1, such as at least 1:1. The pigment-to-binder (P:B) ratio of the calcined clay pigment to the electrodepositable binder may be no more than 2:1, such as no more than 1.5:1, such as no more than 1:1, such as no more than 0.6:1, such as no more than 0.4:1, such as no more than 0.3:1, such as no more than 0.2:1, such as no more than 0.15:1. The pigment-to-binder (P:B) ratio of the calcined clay pigment to the electrodepositable binder may be 0.01:1 to 2:1, such as 0.01:1 to 1.5:1, such as 0.01:1 to 1:1, such as 0.01:1 to 0.6:1, such as 0.01:1 to 0.4:1, such as 0.01:1 to 0.3:1, such as 0.01:1 to 0.2:1, such as 0.01:1 to 0.15:1, such as 0.04:1 to 2:1, such as 0.04:1 to 1.5:1, such as 0.04:1 to 1:1, such as 0.04:1 to 0.6:1, such as 0.04:1 to 0.4:1, such as 0.04:1 to 0.3:1, such as 0.04:1 to 0.2:1, such as 0.04:1 to 0.15:1, such as 0.06:1 to 2:1, such as 0.06:1 to 1.5:1, such as 0.06:1 to 1:1, such as 0.06:1 to 0.6:1, such as 0.06:1 to 0.4:1, such as 0.06:1 to 0.3:1, such as 0.06:1 to 0.2:1, such as 0.06:1 to 0.15:1, such as 0.09:1 to 2:1, such as 0.09:1 to 1.5:1, such as 0.09:1 to 1:1, such as 0.09:1 to 0.6:1, such as 0.09:1 to 0.4:1, such as 0.09:1 to 0.3:1, such as 0.09:1 to 0.2:1, such as 0.09:1 to 0.15:1, such as 0.1:1 to 2:1, such as 0.1:1 to 1.5:1, such as 0.1:1 to 1:1, such as 0.1:1 to 0.6:1, such as 0.1:1 to 0.4:1, such as 0.1:1 to 0.3:1, such as 0.1:1 to 0.2:1, such as 0.1:1 to 0.15:1, such as 0.15:1 to 2:1, such as 0.15:1 to 1.5:1, such as 0.15:1 to 1:1, such as 0.15:1 to 0.6:1, such as 0.15:1 to 0.4:1, such as 0.15:1 to 0.3:1, such as 0.15:1 to 0.2:1, such as 0.2:1 to 2:1, such as 0.2:1 to 1.5:1, such as 0.2:1 to 1:1, such as 0.2:1 to 0.6:1, such as 0.2:1 to 0.4:1, such as 0.2:1 to 0.3:1, such as 0.3:1 to 2:1, such as 0.3:1 to 1.5:1, such as 0.3:1 to 1:1, such as 0.3:1 to 0.6:1, such as 0.3:1 to 0.4:1, such as 0.4:1 to 2:1, such as 0.4:1 to 1.5:1, such as 0.4:1 to 1:1, such as 0.4:1 to 0.6:1, such as 0.6:1 to 2:1, such as 0.6:1 to 1.5:1, such as 0.6:1 to 1:1, such as 0.9:1 to 2:1, such as 0.9:1 to 1.5:1, such as 0.9:1 to 1:1, such as 1:1 to 2:1, such as 1:1 to 1.5:1.

The electrodepositable coating composition may optionally further comprise an additional pigment different than calcined clay.

The total pigment-to-binder ratio of the entire pigment content may be the same as those described above specific to the calcined clay pigment.

The electrodepositable coating and/or electrodepositable coating composition may optionally comprise one or more further components in addition to those described above.

The electrodepositable coating and/or electrodepositable compositions may optionally comprise a corrosion inhibitor. Any suitable corrosion inhibitor may be used. For example, the corrosion inhibitor may comprise a corrosion inhibitor comprising yttrium, lanthanum, cerium, calcium, an azole, or any combination thereof.

Examples of suitable azoles include benzotriazole, 5-methyl benzotriazole, 2-amino thiazole, as well as salts thereof.

The corrosion inhibitor(s) may be present, if at all, in the electrodepositable coating composition in an amount of at least 0.001% by weight, such as at least 5% by weight, based on the total weight of the electrodepositable coating composition. The corrosion inhibitor(s) may be present, if at all, in the electrodepositable coating composition in an amount of no more than 25% by weight, such as no more than 15% by weight, such as no more than 10% by weight, based on the total weight of the electrodepositable coating composition. The corrosion inhibitor(s) may be present, if at all, in the electrodepositable coating composition in an amount of 0.001% to 25% by weight, such as 0.001% to 15% by weight, such as 0.001% to 10% by weight, such as 5% to 25% by weight, such as 5% to 15% by weight, such as 5% to 10% by weight, based on the total weight of the electrodepositable coating composition.

Alternatively, the electrodepositable coating composition may be substantially free, essentially free, or completely free of a corrosion inhibitor. As used herein, with respect to a corrosion inhibitor, “substantially free” means less than 0.001% by weight, “essentially free” means less than 0.0001% by weight, and “completely free” means that corrosion inhibitor is not present, i.e., 0.0000% by weight, based on the total weight of the electrodepositable coating composition.

According to the present disclosure, the electrodepositable coating composition may comprise other optional ingredients, such as if desired, various additives such as fillers, plasticizers, antioxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The other additives mentioned above may each be present in the electrodepositable coating composition in amounts of 0.01% to 3% by weight, based on total weight of the resin solids of the electrodepositable coating composition.

According to the present disclosure, the electrodepositable coating composition may comprise water and/or one or more organic solvent(s). Water can be present in amounts of 40% to 99% by weight, such as 45% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110 °C for one hour.

The electrodepositable coating compositions may be applied by electrophoretically applying the coating composition to at least a portion of any suitable substrate, such as an electroconductive substrate. As used herein, a substrate may mean a bare substrate as well as a substrate that is previously treated or coated with one or more layers, such as a pretreatment, such as a zinc phosphate pretreatment layer.

Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise cold rolled steel, hot rolled steel, stainless steel, steel coated with zinc metal, zinc compounds, or zinc alloys, such as electrogalvanized steel, hot-dipped galvanized steel, galvannealed steel, and steel plated with zinc alloy. Aluminum alloys of the 2XXX, 3XXX, 4XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, trucks, tanks, and/or armored cars or trucks. The metal substrate also may be in the form of a sheet of metal or a fabricated part. It will also be understood that the substrate may be pretreated with a pretreatment solution including a zinc phosphate pretreatment solution such as those described in U.S. Pat. Nos. 4,793,867 and 5,588,989, or a zirconium containing pretreatment solution such as those described in U.S. Pat. Nos. 7,749,368 and 8,673,091.

The substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2). The substrate may comprise surfaces or parts of different substrate materials that are adjacent or joined together such as a galvanic assembly.

The coating composition may be electrophoretically applied to the electroconductive substrate and at least partially cured using application conditions, times, and temperatures, as known to those skilled in the art.

The cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent film of the coating composition may be deposited on the cathode when a sufficient voltage is impressed between the electrodes.

The anionic electrodepositable coating composition of the present disclosure may be deposited upon an electrically conductive substrate by placing the composition in contact with an electrically conductive cathode and an electrically conductive anode, with the surface to be coated being the anode. Following contact with the composition, an adherent film of the coating composition may be deposited on the anode when a sufficient voltage is impressed between the electrodes.

The applied voltage in the electrophoretic application of the electrodepositable coating compositions of the present disclosure, may be varied and may be, for example, as low as one volt to as high as several thousand volts, such as between 50 and 500 volts. The current density may, for example, be between 0.5 ampere and 15 amperes per square foot and tends to decrease during electrodeposition indicating the formation of an insulating film.

The substrate, coated at least in part with an electrodepositable coating layer deposited from the coating compositions of the present disclosure, may be heated to a temperature and for a time sufficient to at least partially cure the electrodeposited coating on the substrate. As used herein, the term “at least partially cure” refers to subjecting the coating composition to curing conditions such that at least a portion of the reactive groups of the components of the coating composition cure or crosslink to form a coating. In general, the substrate may be heated to a temperature ranging from 250 °F to 450 °F (121.1 °C to 232.2 °C), such as from 275 °F to 400 °F (135 °C to 204.4 °C), such as from 300 °F to 360 °F (149 °C to 180 °C). For purposes of the present disclosure, all that is necessary is that the time be sufficient to effect cure of the coating on the substrate. The curing time may range from 10 minutes to 60 minutes, such as 20 to 40 minutes. The thickness of the resultant cured electrodeposited coating is not limited and may optionally range from 15 to 50 microns.

The present disclosure is also directed to methods for coating a substrate, such as any one of the electroconductive substrates mentioned above. According to the present disclosure such method may comprise electrophoretically applying an electrodepositable coating composition as described above to at least a portion of the substrate and curing the coating composition to form an at least partially cured coating on the substrate. According to the present disclosure, the method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. According to the present disclosure, the method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the topcoat.

The electrodepositable coating compositions of the present disclosure may comprise a multi-layer coating system. The coating layer deposited from the present composition may have one or more additional coating layers deposited under and/or over the layer. For example, the coating system may comprise a pretreatment layer, such as a phosphate layer (e.g., zinc phosphate layer), and the electrodepositable coating composition described in the present disclosure may be deposited over at least a portion of the pretreated layer; one or more additional coating layers may be applied over at least a portion of the electrodeposited coating layer. In addition to the electrodepositable coating composition of the present disclosure, the coating system may include one or more pretreatment layers, and one or more additional coating layers comprising primers, basecoats, color coats, monocoats, clear coats and/or topcoats. Suitable additional coating layers include any of those known in the art, and each independently may be waterborne, solventborne, in solid particulate form (i.e., a powder coating composition), or in the form of a powder slurry. The additional coating layers may each be cured independently, or optionally applied “wet-on-wet” and cured simultaneously. As used herein, “wet-on-wet” refers to a process, wherein a coating, such as a clear coat, is applied over a substantially uncured different coating, such as a color coat, and both coatings are then cured simultaneously.

The coating system may optionally comprise one, or a mixture of two or more, of any colorants and/or fillers, as known to those skilled in the art, in any coating layer or layers, in any amounts sufficient to impart the desired property, visual and/or color effect.

The present disclosure is also directed to a coated substrate comprising a coating deposited from the electrodepositable coating composition described above.

The coated substrate may be coated by the method described herein.

The coated substrate may comprise an electrodeposited binder comprising: a reaction product of an active hydrogen-containing, ionic salt group-containing film-forming polymer and a curing agent; at least one organic resinous component different than the active hydrogen-containing, ionic salt group-containing film-forming polymer and curing agent, wherein the organic resinous component has an aliphatic content of at least 60% by weight, based on the total weight of the organic resinous component, such as at least 65% by weight, such as at least 70% by weight, such as at least 75% by weight, such as at least 77% by weight, such as at least 80% by weight, such as at least 83% by weight, such as at least 86% by weight, such as at least 89% by weight, such as at least 92% by weight, such as at least 95% by weight; a curing catalyst comprising a bismuth-containing curing catalyst, an amine-containing curing catalyst, a zinc-containing curing catalyst, a zirconium-containing catalyst, a cerium-containing catalyst, an amidine-containing catalyst, an imidazole-containing catalyst, and/or a titanium-containing catalyst; and calcined clay pigment.

The coating resulting from electrodepositing the electrodepositable coating composition of the present disclosure may have two or more resin domains, a first resin domain and a second resin domain.

As used herein, the terms “resin domain” in first resin domain or second resin domain refers to a visible disruption in the homogeneity of the binder. The visible disruption may be visible using TEM and/or SEM. The first resin domain may be the bulk resin and the second resin domain may be present as resinous areas that are phase separate from the bulk resin. The second resin domain may be dispersed pockets of resin dispersed throughout the bulk resin of the first resin domain. The dispersed pockets of resin may have any geometric shape or morphology, such as spherical, lamellar, cylindrical, etc. The dispersed pockets may be generally uniformly dispersed or may be inconsistently dispersed. The dispersed pockets may also be stratified throughout the bulk resin. Alternatively, the first resin domain and second resin domain may be phase separated into a bi-layer configuration wherein one of the resin domains is present on the substrate surface and the other resin domain is present on top of that domain. The second resin domain may be generally free of the calcined clay pigment.

The first resin domain may have a first glass transition temperature, and the second resin domain may have a second glass transition temperature. The first glass transition temperature may be at least 10 °C, such as at least 20 °C, such as at least 30 °C, such as at least 40 °C, such as at least 50 °C, such as at least 60 °C, such as at least 70 °C, such as at least 80 °C, such as at least 90 °C, such as at least 100 °C, such as at least 110 °C, such as at least 120 °C greater, such as at least 130 °C, such as at least 140 °C, such as at least 150 °C, such as at least 160 °C, such as at least 170 °C greater than the second glass transition temperature, and the second glass transition temperature is greater than −50 °C.

The first glass transition temperature may be at least 80 °C, such as at least 90 °C, such as at least 100 °C, such as at least 110 °C, such as at least 120 °C, such as at least 125 °C. The first glass transition temperature may be no more than 130 °C, such as no more than 120 °C, such as no more than 110 °C, such as no more than 100 °C, such as no more than 90 °C. The first glass transition temperature may be from 80 °C to 130 °C, such as 80 °C to 120 °C, such as 80 °C to 110 °C, such as 80 °C to 100 °C, such as 80 °C to 90 °C, such as 90 °C to 130 °C, such as 90 °C to 120 °C, such as 90 °C to 110 °C, such as 90 °C to 100 °C, such as 100 °C to 130 °C, such as 100 °C to 120 °C, such as 100 °C to 110 °C, such as 110 °C to 130 °C, such as 110 °C to 120 °C, such as 120 °C to 130 °C.

The second glass transition temperature may be at least −50 °C, such as at least −40 °C, such as at least −30 °C, such as at least −20 °C, such as at least −10 °C, such as at least 0 °C, such as at least 10 °C, such as at least 20 °C, such as at least 30 °C, such as at least 40 °C, such as at least 50 °C, such as at least 60 °C. The second glass transition temperature may be no more than 70 °C, such as no more than 50 °C, such as no more than 30 °C, such as no more than 10 °C, such as no more than 0 °C, such as no more than −10 °C, such as no more than −20 °C, such as no more than −30 °C. The second glass transition temperature may be from −50 °C to 70 °C, such as −50 °C to 50 °C, such as −50 °C to 30 °C, such as −50 °C to 10 °C, such as −50 °C to 0 °C, such as −50 °C to −10 °C, such as −50 °C to −20 °C, such as −50 °C to −30 °C, such as −40 °C to 70 °C, such as −40 °C to 50 °C, such as −40 °C to 30 °C, such as −40 °C to 10 °C, such as −40 °C to 0 °C, such as −40 °C to −10 °C, such as −40 °C to −20 °C, such as −40 °C to −30 °C, such as −30 °C to 70 °C, such as −30 °C to 50 °C, such as −30 °C to 30 °C, such as −30 °C to 10 °C, such as −30 °C to 0 °C, such as −30 °C to −10 °C, such as −30 °C to −20 °C, such as −20 °C to 70 °C, such as −20 °C to 50 °C, such as −20 °C to 30 °C, such as −20 °C to 10 °C, such as −20 °C to 0 °C, such as −20 °C to −10 °C, such as −10 °C to 70 °C, such as −10 °C to 50 °C, such as −10 °C to 30 °C, such as −10 °C to 10 °C, such as −10 °C to 0 °C, such as 0 °C to 70 °C, such as 0 °C to 50 °C, such as 0 °C to 30 °C, such as 0 °C to 10 °C, such as 10 °C to 70 °C, such as 10 °C to 50 °C, such as 10 °C to 30 °C, such as 20 °C to 70 °C, such as 20 °C to 50 °C, such as 20 °C to 30 °C, such as 30 °C to 70 °C, such as 30 °C to 50 °C, such as 40 °C to 70 °C, such as 40 °C to 50 °C, such as 50 °C to 70 °C, such as 60 °C to 70 °C.

The electrodeposited coating optionally may further comprise a third glass transition temperature, and, if the third glass transition temperature is present, the third glass transition temperature may or may not correspond to the presence of a third resin domain. If present, the third glass transition temperature may be less than −50 °C.

The glass transition temperatures may be measured according to the following procedure: A conductive electrocoat may be first used to generate free films of the example electrocoats. The formulation and use of the conductive electrocoat is detailed as follows: The conductive electrocoat may be made using commercially available PPG products under product codes CR756 and CP639. Deionized water (1959 g) may be added to 2093 g of CR756 and 220 g of CP639 paste under agitation for one hour. This material may then be used to electrocoat panels using the technical bulletin specifications.

CRS panels pretreated with zinc phosphate (C700/DI; item number 28630 available from ACT, Hillsdale, MI.) are cut in half to yield a 4″ by 6″ panel. These cut panels are submerged in the conductive electrocoat and electrodeposition is carried out using a rectifier (Xantrax Model XFR600-2, Elkhart, Indiana, or Sorensen XZG 300-5.6, Ameteck, Berwyn, Pennsylvania) that is DC-power supplied. The target film build is 0.5-0.7 mils (12.7-17.8 microns) on the vertical face of the panel. To achieve the target film build per panel, the electrocoat bath is maintained at 80 °F and uses 115 volts with a 0.75 amp limit set. Coating continued until 40 coulombs are generated. After panels are electrocoated, these panels are rinsed with deionized water and baked at 219 °C for 90 minutes in an electric oven (Despatch Model LFD-1-42).

The panels coated in the conductive electrocoat are then submerged in the example electrocoats and electrodeposition may be carried out using a rectifier (Xantrax Model XFR600-2, Elkhart, Indiana, or Sorensen XZG 300-5.6, Ameteck, Berwyn, Pennsylvania) which was DC-power supplied. The target film build is 15-25 microns on the vertical face of the panel. After panels are electrocoated, the panels are rinsed with deionized water and baked at target bake conditions (155 °C, 165 °C, or 175 °C) for 30 minutes in an electric oven (Despatch Model LFD-1-42). The example electrocoat may then be peeled off from the conductive electrocoat panel and used to measure glass transition temperature.

Glass transition temperatures (T_{g}) may then be measured using a dynamic mechanical analyzer (DMA). A TA Instruments DMA Q800 apparatus was employed in tensile mode with a preload force of 10 mN, amplitude of 15 m (tensile strain<0.3%), static stress/dynamic stress amplitude ratio (“force tracking”) of 125%, and an oscillation frequency of 1 Hz. The samples were first cut into a rectangular shape, featuring a width of 7 mm, gauge length of 15 mm, and thickness of 25 μm. After loading each film specimen at room temperature under tensile stress, they were cooled to −100 °C, thermally equilibrated, and ramped to 250 °C at 3 °C/min. The glass transition temperatures were determined by peak temperature value of loss tangent (tan δ).

The coating may have an elongation at break of at least 1%, such as at least 1.25%, such as greater than 1.50%, such as at least 1.75%, such as at least 2%, such as at least 2.25%, such as at least 2.5%, such as at least 2.75%, such as at least 3%, such as at least 3.25%, such as at least 3.5%, such as at least 3.75%, such as at least 4%. The tensile elongation at break of the coatings may be measured according to ASTM-D638 using a 6.25 mm by 25.4 mm free coating film having a thickness of 15 to 25 microns with the tensile elongation at break (%) determined by the maximum strain values in the stress-strain curve from 100 mm/min.

The coating may have a tensile toughness of at least 0.15 MPa, such as at least 0.20 MPa, such as at least 0.25 MPa, such as at least 0.30 MPa, such as at least 0.35 MPa, such as at least 0.4 MPa, such as at least 0.5 MPa, such as at least 0.7 MPa, such as at least 0.8 MPa, such as at least 1 MPa. The tensile toughness of the coatings may be measured according to ASTM-D638 using a 10 mm by 100 mm×15 to 25 micron thick (with gauge length of 25 mm) free coating film.

The coating may have a tensile strength of at least 20 MPa, such as at least 23 MPa, such as at least 25 MPa, such as at least 28 MPa, such as at least 30 MPa, such as at least 32 MPa, such as at least 40 MPa, such as at least 45 MPa, such as at least 50 MPa. The tensile strength of the coatings may be measured according to ASTM-D638 using a 6.25 mm by 25.4 mm free coating film having a thickness of 18 to 25 microns.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. Nevertheless, they also include the more restrictive terms “consisting of” and “consisting essentially of”. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “an” active hydrogen-containing, ionic salt group-containing film-forming polymer, “a” curing agent, “an” organic resinous component, “a” curing catalyst, “a” calcined clay pigment, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

### Aspects

Aspect 1. An electrodepositable coating composition comprising: an active hydrogen-containing, ionic salt group-containing film-forming polymer; a curing agent; at least one organic resinous component different than the active hydrogen-containing, ionic salt group-containing film-forming polymer and curing agent, wherein the organic resinous component has an aliphatic content of at least 60% by weight, based on the total weight of the organic resinous component, such as at least 65% by weight, such as at least 70% by weight, such as at least 75% by weight, such as at least 77% by weight, such as at least 80% by weight, such as at least 83% by weight, such as at least 86% by weight, such as at least 89% by weight, such as at least 92% by weight, such as at least 95% by weight; a curing catalyst comprising a bismuth-containing curing catalyst, an amine-containing curing catalyst, a zinc-containing curing catalyst, a zirconium-containing catalyst, a cerium-containing catalyst, an amidine-containing catalyst, an imidazole-containing catalyst, and/or a titanium-containing catalyst; and calcined clay pigment.
Aspect 2. The electrodepositable coating composition of aspect 1, wherein the active hydrogen-containing, ionic salt group-containing film-forming polymer has an aromatic content of at least 10% by weight, based on the total weight of the active hydrogen-containing, ionic salt group-containing film-forming polymer, such as at least 15% by weight, such as at least 20% by weight, such as at least 25% by weight, such as at least 30% by weight, such as at least 35% by weight, such as at least 40% by weight.
Aspect 3. The electrodepositable coating composition of any of the preceding aspects, wherein the organic resinous component comprises cationic and/or cationic salt groups.
Aspect 4. The electrodepositable coating composition of any of the preceding aspects, wherein the organic resinous component comprises an amine.
Aspect 5. The electrodepositable coating composition of any of the preceding aspects, wherein the aliphatic content of the organic resinous component comprises: a polyether; a polyalkylene glycol; a poly(alkyl-1,2-diol); polyethylene oxide; polypropylene oxide; polybutylene oxide; an aliphatic compound having two or more epoxide functional groups reacted with an aliphatic compound having one or more amine functional groups; and/or a combination thereof.
Aspect 6. The electrodepositable coating composition of any of the preceding aspects, wherein the organic resinous component has: a glass transition temperature of <0 °C, such as <−5 °C, such as <−10 °C, such as <−15 °C, such as <−20 °C, such as <−25 °C, such as <−30 °C; a hydroxyl value of <130 mg KOH/g organic resinous component, such as <125 mg KOH/g organic resinous component, such as <120 mg KOH/g organic resinous component; a z-average molecular weight (M_{z}) of at least 10,000 g/mol, such as at least 15,000 g/mol, such as at least 20,000 g/mol, such as at least 25,000 g/mol, such as at least 30,000 g/mol; a weight average molecular weight (M_{w}) of at least 5,000 g/mol, such as at least 7,500 g/mol, such as at least 10,000 g/mol, such as at least 12,500 g/mol, such as at least 15,000 g/mol; and/or a number average molecular weight (Mₙ) of at least 2,000 g/mol, such as at least 2,250 g/mol, such as at least 2,500 g/mol, such as at least 2,750 g/mol, such as at least 3,000 g/mol, such as at least 5,000 g/mol, such as at least 7,000 g/mol.
Aspect 7. The electrodepositable coating composition of any of the preceding aspects, wherein the organic resinous component comprises a polyetheramine adduct.
Aspect 8. The electrodepositable coating composition of aspect 7, wherein the polyetheramine adduct comprises an ungelled ionic reaction product prepared from reactants comprising: (a) a reaction product prepared from reactants comprising: (1) a di-functional chain extender; and (2) an epoxy functional material; and (b) a polyetheramine.
Aspect 9. The electrodepositable coating composition of aspect 8, wherein: the di-functional chain extender comprises bisphenol A, bisphenol F, resorcinol, dihydroxy benzene, aliphatic, cycloaliphatic or aralaphatic hydroxyl containing compounds, such as ethylene glycol, propylene glycol, dihydroxyl cyclohexane, dimethylol cyclohexane, or combinations thereof; the epoxy-functional material comprises a di- or polyglycidyl ether of a polyhydric alcohol, such as a polyglycidyl ether of bisphenol A; and/or the polyetheramine comprises an aminated polymer comprising propylene oxide, ethylene oxide, or mixed propylene oxide and ethylene oxide repeating units, such as aminated propoxylated pentaerythritols or any according to Formula (I), (II), or (III), or combinations thereof:

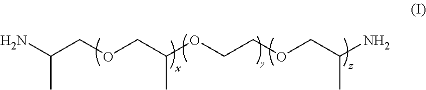

wherein y=0-39, x+z=1-68;

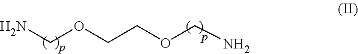

wherein each p independently is 2 or 3; or

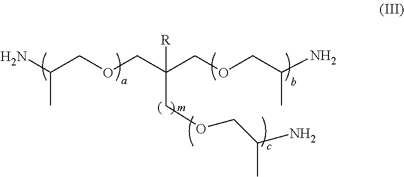

wherein R is H or C₂H₅, m=0 or 1, a+b+c=5-85.
Aspect 10. The electrodepositable coating composition of aspects 7-9, wherein the polyetheramine adduct has a polypropylene oxide content of at least 60% by weight, based on the total weight of the polyetheramine adduct.
Aspect 11. The electrodepositable coating composition of any of the preceding aspects, wherein the organic resinous component comprises: an acrylic polymer; a polyester; and/or a urethane.
Aspect 12. The electrodepositable coating composition of any of the preceding aspects, wherein the calcined clay is present in an amount such that the calcined clay pigment-to-binder ratio is at least 0.01, such as at least 0.04:1, such as at least 0.06:1, such as at least 0.09:1, such as at least 0.1:1, such as at least 0.15:1, such as at least 0.2:1, such as at least 0.3:1, such as at least 0.4:1, such as at least 0.6:1, such as at least 0.8:1, such as at least 1:1.
Aspect 13. The electrodepositable coating composition of any of the preceding aspects, wherein the calcined clay has a Mohs hardness of greater than 2.5, such as at least 2.8, such as at least 3.0.
Aspect 14. The electrodepositable coating composition of any of the preceding aspects, wherein the calcined clay has an oil absorption of greater than 10 mL per 100 g, such as at least 20 mL per 100 g, such as at least 30 mL per 100 g, such as at least 40 mL per 100 g, such as at least 50 mL per 100 g, such as at least 60 mL per 100 g, such as at least 70 mL per 100 g, such as at least 80 mL per 100 g, determined according to ASTM D6854-12a (2014).
Aspect 15. The electrodepositable coating composition of any of the preceding aspects, wherein the calcined clay has a BET surface area of less than 19 m²/g, such as less than 17 m²/g, such as less than 15 m²/g, such as less than 13 m²/g.
Aspect 16. The electrodepositable coating composition of any of the preceding aspects, further comprising an additional pigment different than calcined clay.
Aspect 17. The electrodepositable coating composition of any of the preceding aspects, wherein the electrodepositable coating composition is substantially free, essentially free, or completely free of catalytic tin.
Aspect 18. An electrodepositable coating composition comprising: an active hydrogen-containing, ionic salt group-containing film-forming polymer; a curing agent; at least one organic resinous component different than the active hydrogen-containing, ionic salt group-containing film-forming polymer and curing agent, wherein the organic resinous component has an aliphatic content of at least 60% by weight, based on the total weight of the organic resinous component, such as at least 65% by weight, such as at least 70% by weight, such as at least 75% by weight, such as at least 80% by weight, such as at least 85% by weight, such as at least 90% by weight, such as at least 95% by weight; and calcined clay pigment; wherein the electrodepositable coating composition is substantially free, essentially free, or completely free of catalytic tin.
Aspect 19. The electrodepositable coating composition of any of the preceding aspects, wherein a coating deposited from the electrodepositable coating composition having at least one of: an elongation at break of at least 1%, such as at least 1.25%, such as greater than 1.50%, such as at least 1.75%, such as at least 2%, such as at least 2.25%, such as at least 2.5%, such as at least 2.75%, such as at least 3%, such as at least 3.25%, such as at least 3.5%, such as at least 3.75%, such as at least 4%; a tensile toughness of at least 0.15 MPa, such as at least 0.20 MPa, such as at least 0.25 MPa, such as at least 0.30 MPa, such as at least 0.35 MPa, such as at least 0.4 MPa, such as at least 0.5 MPa, such as at least 0.7 MPa, such as at least 0.8 MPa, such as at least 1 MPa; a tensile strength of at least 20 MPa, such as at least 23 MPa, such as at least 25 MPa, such as at least 28 MPa, such as at least 30 MPa, such as at least 32 MPa, such as at least 40 MPa, such as at least 45 MPa, such as at least 50 MPa; an electrodeposited binder comprising: a first resin domain having a first glass transition temperature; and a second resin domain having a second glass transition temperature, wherein the first glass transition temperature is at least 10 °C, such as at least 20 °C, such as at least 30 °C, such as at least 40 °C, such as at least 50 °C, such as at least 60 °C, such as at least 70 °C, such as at least 80 °C, such as at least 90 °C, such as at least 100 °C, such as at least 110 °C, such as at least 120 °C greater, such as at least 130 °C, such as at least 140 °C, such as at least 150 °C, such as at least 160 °C, such as at least 170 °C greater than the second glass transition temperature, and the second glass transition temperature is greater than −50 °C; and/or an electrodeposited binder comprising: a first resin domain having a first glass transition temperature of at least 80 °C; and a second resin domain having a second glass transition temperature of from −50 °C to 70 °C.
Aspect 20. A method of coating a conductive substrate comprising applying the electrodepositable coating composition of any of the preceding aspects to at least a portion of a surface of the conductive substrate.
Aspect 21. A coated substrate coated by the method of aspect 20.
Aspect 22. A coated substrate comprising a coating deposited from the electrodepositable coating composition of any of the preceding aspects 1-19.
Aspect 23. A coated substrate comprising: an electrodeposited binder comprising: a reaction product of an active hydrogen-containing, ionic salt group-containing film-forming polymer and a curing agent; at least one organic resinous component different than the active hydrogen-containing, ionic salt group-containing film-forming polymer and curing agent, wherein the organic resinous component has an aliphatic content of at least 60% by weight, based on the total weight of the organic resinous component, such as at least 65% by weight, such as at least 70% by weight, such as at least 75% by weight, such as at least 77% by weight, such as at least 80% by weight, such as at least 83% by weight, such as at least 86% by weight, such as at least 89% by weight, such as at least 92% by weight, such as at least 95% by weight; a curing catalyst comprising a bismuth-containing curing catalyst, an amine-containing curing catalyst, a zinc-containing curing catalyst, a zirconium-containing catalyst, a cerium-containing catalyst, an amidine-containing catalyst, an imidazole-containing catalyst, and/or a titanium-containing catalyst; and calcined clay pigment.
Aspect 24. The coated substrate of any of aspects 21-23, wherein the coating has an elongation at break of at least 1%, such as at least 1.25%, such as greater than 1.50%, such as at least 1.75%, such as at least 2%, such as at least 2.25%, such as at least 2.5%, such as at least 2.75%, such as at least 3%, such as at least 3.25%, such as at least 3.5%, such as at least 3.75%, such as at least 4%.
Aspect 25. The coated substrate of any of aspects 21-24, wherein the coating has a tensile toughness of at least 0.15 MPa, such as at least 0.20 MPa, such as at least 0.25 MPa, such as at least 0.30 MPa, such as at least 0.35 MPa, such as at least 0.4 MPa, such as at least 0.5 MPa, such as at least 0.7 MPa, such as at least 0.8 MPa, such as at least 1 MPa.
Aspect 26. The coated substrate of any of aspects 21-25, wherein the coating has a tensile strength of at least 20 MPa, such as at least 23 MPa, such as at least 25 MPa, such as at least 28 MPa, such as at least 30 MPa, such as at least 32 MPa, such as at least 40 MPa, such as at least 45 MPa, such as at least 50 MPa.
Aspect 27. The coated substrate of any of aspects 21-26, wherein the coating comprises an electrodeposited binder comprising a first resin domain and a second resin domain.
Aspect 28. The coated substrate of any of aspects 21-27, wherein the coating comprises an electrodeposited binder comprising: a first resin domain having a first glass transition temperature; and a second resin domain having a second glass transition temperature, wherein the first glass transition temperature is at least 10 °C, such as at least 20 °C, such as at least 30 °C, such as at least 40 °C, such as at least 50 °C, such as at least 60 °C, such as at least 70 °C, such as at least 80 °C, such as at least 90 °C, such as at least 100 °C, such as at least 110 °C, such as at least 120 °C greater, such as at least 130 °C, such as at least 140 °C, such as at least 150 °C, such as at least 160 °C, such as at least 170 °C greater than the second glass transition temperature, and the second glass transition temperature is greater than −50 °C.
Aspect 29. The coated substrate of any of aspects 21-28, wherein the coating comprises an electrodeposited binder comprising: a first resin domain having a first glass transition temperature of at least 80 °C; and a second resin domain having a second glass transition temperature of from −50 °C to 70 °C.
Aspect 30. A use of the electrodepositable coating composition of any of aspects 1-19 for making a coating having at least one of: an elongation at break of at least 1%, such as at least 1.25%, such as greater than 1.50%, such as at least 1.75%, such as at least 2%, such as at least 2.25%, such as at least 2.5%, such as at least 2.75%, such as at least 3%, such as at least 3.25%, such as at least 3.5%, such as at least 3.75%, such as at least 4%; a tensile toughness of at least 0.15 MPa, such as at least 0.20 MPa, such as at least 0.25 MPa, such as at least 0.30 MPa, such as at least 0.35 MPa, such as at least 0.4 MPa, such as at least 0.5 MPa, such as at least 0.7 MPa, such as at least 0.8 MPa, such as at least 1 MPa; a tensile strength of at least 20 MPa, such as at least 23 MPa, such as at least 25 MPa, such as at least 28 MPa, such as at least 30 MPa, such as at least 32 MPa, such as at least 40 MPa, such as at least 45 MPa, such as at least 50 MPa; an electrodeposited binder comprising a first resin domain and a second resin domain; an electrodeposited binder comprising: a first resin domain having a first glass transition temperature; and a second resin domain having a second glass transition temperature, wherein the first glass transition temperature is at least 10 °C, such as at least 20 °C, such as at least 30 °C, such as at least 40 °C, such as at least 50 °C, such as at least 60 °C, such as at least 70 °C, such as at least 80 °C, such as at least 90 °C, such as at least 100 °C, such as at least 110 °C, such as at least 120 °C greater, such as at least 130 °C, such as at least 140 °C, such as at least 150 °C, such as at least 160 °C, such as at least 170 °C greater than the second glass transition temperature, and the second glass transition temperature is greater than −50 °C; and/or an electrodeposited binder comprising: a first resin domain having a first glass transition temperature of at least 80 °C; and a second resin domain having a second glass transition temperature of from −50 °C to 70 °C.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1. Preparation of Blocked Polyisocyanate Curing Agent (Crosslinker I)

| # | Material | Parts by Weight |
|---|---|---|
| 1 | Polymeric methylenediphenyl | 1483.6 |
| | diisocyanate¹ | |
| 2 | Dibutyltin dilaurate | 1.4 |
| 3 | Methyl isobutyl ketone (MIBK) | 77.7 |
| 4 | 2-(2-Butoxyethoxy)ethanol | 358.7 |
| 5 | 2-Butoxyethanol | 1045.2 |
| 6 | MIBK | 33.3 |

¹Mondur MR, available from Covestro (NCO Eq Wt = 132)

A blocked polyisocyanate curing agent was prepared in the following manner. Components 2-5 were mixed in a flask set up for total reflux with stirring under nitrogen. The mixture was heated to a temperature of 30 °C, and Component 1 was added slowly so that the temperature increased due to the reaction exotherm and was maintained below 100 °C. After the addition of Component 1 was complete, the reaction mixture was held at 100 °C until no residual isocyanate was detected by IR spectroscopy. Component 6 was then added, and the reaction mixture was allowed to stir for 30 minutes to yield the product.

### Example 2. Preparation of Active Hydrogen-Containing, Ionic Salt Group-Containing Film-Forming Polymer (Resin Dispersion 1)

Resin Synthesis Stage

| # | Material | Parts by Weight |
|---|---|---|
| 1 | EPON 828¹ | 991.2 |
| 2 | Bisphenol A | 427.8 |
| 3 | Bisphenol A-ethylene oxide adduct | 401.4 |
| | (⅙ molar ratio BPA/EO) | |
| 4 | Methyl isobutyl ketone (MIBK) | 36.2 |
| 5 | Ethyltriphenylphosphonium bromide | 1.0 |
| 6 | MIBK | 220.9 |
| 7 | Crosslinker I | 1065.7 |
| 8 | Diethylenetriamine-MIBK diketimine² | 92.0 |
| 9 | N-Methylethanolamine | 78.2 |

Dispersion Stage

| | | |
|---|---|---|
| 10 | Resin Synthesis Product | 2889.7 |
| 11 | Formic acid, 90% aqueous | 33.2 |
| 12 | Deionized water | 1795.8 |
| 13 | Deionized water | 1383.4 |
| 14 | Deionized water | 1218.3 |

¹Diglycidyl ether of bisphenol A with an epoxy equivalent weight of 185-192, available from Westlake.
²72.7% by weight (in MIBK) of the diketimine reaction product of 1 equivalent of diethylenetriamine and 2 equivalents of MIBK.

An active hydrogen-containing, ionic salt group-containing film-forming polymer was prepared in the following manner. Components 1-5 were mixed in a flask set up for total reflux with stirring under nitrogen. The mixture was heated to a temperature of 130 °C and allowed to exotherm (175 °C maximum temperature). A temperature of 145 °C was then established, and the reaction mixture was held for 2 hours. Component 6 was introduced slowly while allowing the mixture to cool to 125 °C, followed by addition of Component 7. A temperature of 105 °C was established, and Components 8-9 were added to the reaction mixture in rapid succession. The reaction mixture was allowed to exotherm, after which the mixture was held at 115 °C for 1 hour to yield a Resin Synthesis Product (Component 10). A portion of the Resin Synthesis Product, as Component 10, was then poured into a pre-mixed solution of Components 11-12 to form a resin dispersion, and the resin dispersion was mixed for 30 minutes. Component 13 was introduced over 30 minutes, and the dispersion was mixed for a further 30 minutes. Component 14 was then added, and the dispersion was mixed well. Free MIBK was subsequently removed from the dispersion by distillation under vacuum at a temperature of 60-70 °C, affording a product with a final solids content of 40.2%.

### Example 3. Preparation of Active Hydrogen-Containing, Ionic Salt Group-Containing Film-Forming Polymer (Resin Dispersion 2)

Resin Synthesis Stage

| # | Material | Parts by Weight |
|---|---|---|
| 1 | Epon 828¹ | 541.1 |
| 2 | Bisphenol A | 232.1 |
| 3 | Bisphenol A-ethylene oxide adduct | 222.4 |
| | (⅙ molar ratio BPA/EO) | |
| 4 | Methyl isobutyl ketone (MIBK) | 20.2 |
| 5 | Ethyltriphenylphosphonium iodide | 0.5 |
| 6 | MIBK | 151.2 |
| 7 | Crosslinker I | 599.2 |
| 8 | Diethylenetriamine-MIBK diketimine² | 50.2 |
| 9 | N-Methylethanolamine | 42.5 |
| 10 | K-KAT XK-614³ | 24.9 |

Dispersion Stage

| | | |
|---|---|---|
| 11 | Resin Synthesis Product | 1618.5 |
| 12 | Formic acid, 90% aqueous | 18.3 |
| 13 | Deionized water | 965.4 |
| 14 | Deionized water | 761.3 |
| 15 | Deionized water | 669.7 |

¹Diglycidyl ether of bisphenol A with an epoxy equivalent weight of 185-192 g/eq, available from Westlake.
²72.7% by weight (in MIBK) of the diketimine reaction product of 1 equivalent of diethylenetriamine and 2 equivalents of MIBK.
³100% Active Zinc-amine complex, available from King Industries.

An active hydrogen-containing, ionic salt group-containing film-forming polymer was prepared in the following manner. Components 1-5 were mixed in a flask set up for total reflux with stirring under nitrogen. The mixture was heated to a temperature of 130 °C and allowed to exotherm (175 °C maximum temperature). A temperature of 145 °C was then established, and the reaction mixture was held for 2 hours. Component 6 was introduced slowly while allowing the mixture to cool to 125 °C, followed by addition of Component 7. A temperature of 105 °C was established, and Components 8-9 were added to the reaction mixture in rapid succession. The reaction mixture was allowed to exotherm, after which the mixture was held at 115 °C for 1 hour. Finally, Component 10 was added and mixed for 15 minutes at 115 °C to yield a Resin Synthesis Product (Component 11). A portion of the Resin Synthesis Product, as Component 11, was then poured into a pre-mixed solution of Components 12-13 to form a resin dispersion, and the resin dispersion was mixed for 30 minutes. Component 14 was introduced over 30 minutes, and the dispersion was mixed for a further 30 minutes. Component 15 was then added, and the dispersion was mixed well. Free MIBK was subsequently removed from the dispersion by distillation under vacuum at a temperature of 60-70 °C, affording a product with a final solids content of 42.5%.

### Example 4a. Preparation of Polyisocyanate Curing Agent (Crosslinker II)

| # | Material | Parts by Weight |
|---|---|---|
| 1 | Polymeric 4,4'-methylenebis(phenyl | 1560.3 |
| | isocyanate)¹ | |
| 2 | Dibutyltin dilaurate | 1.4 |
| 3 | Methyl isobutyl ketone (MIBK) | 446.7 |
| 4 | 2-(2-Butoxyethoxy)ethanol | 566.1 |
| 5 | Propane-1,2-diol | 620.0 |
| 6 | MIBK | 53.9 |
| 7 | Bis[2-(2-butoxyethoxy)ethoxy]methane² | 58.0 |

¹Available from Covestro as Mondur MR, equivalent weight average 132 g/eq and a minimum isocyanate (NCO) content of 31.0%.
²Available as Mazon 1651 from BASF.

A blocked polyisocyanate curing agent was prepared in the following manner. Components 2-5 were mixed in a flask set up for total reflux with stirring under nitrogen. The mixture was heated to a temperature of 30 °C, and Component 1 was added slowly so that the temperature increased due to the reaction exotherm and was maintained below 100 °C. After the addition of Component 1 was complete, the reaction mixture was held at 100 °C until no residual isocyanate was detected by IR spectroscopy. Components 6-7 were then added, and the reaction mixture was allowed to stir for 30 minutes to yield the product.

### Example 4. Preparation of Active Hydrogen-Containing, Ionic Salt Group-Containing Film-Forming Polymer (Resin Dispersion 3)

Resin Synthesis Stage

| # | Material | Parts by Weight |
|---|---|---|
| 1 | Epon 828¹ | 927.4 |
| 2 | Bisphenol A | 399.8 |
| 3 | Bisphenol A-ethylene oxide | 405.8 |
| | adduct (⅙ molar ratio BPA/EO) | |
| 4 | Methyl isobutyl ketone (MIBK) | 53.2 |
| 5 | Ethyltriphenylphosphonium bromide | 1.4 |
| 6 | MIBK | 11.9 |
| 7 | Crosslinker II | 1352.4 |
| 8 | Diethylenetriamine-MIBK diketimine² | 86.2 |
| 9 | N-Methylethanolamine | 73.1 |

Dispersion Stage

| | | |
|---|---|---|
| 10 | Resin Synthesis Product | 2990.3 |
| 11 | Formic acid, 90% aqueous | 41.1 |
| 12 | Deionized water | 1159.2 |
| 13 | Deionized water | 2606.3 |
| 14 | Deionized water | 1357.6 |

¹Diglycidyl ether of bisphenol A with an epoxy equivalent weight of 185-192 g/eq, available from Westlake.
²72.7% by weight (in MIBK) of the diketimine reaction product of 1 equivalent of diethylenetriamine and 2 equivalents of MIBK.

An active hydrogen-containing, ionic salt group-containing film-forming polymer was prepared in the following manner. Components 1-5 were mixed in a flask set up for total reflux with stirring under nitrogen. The mixture was heated to a temperature of 130 °C and allowed to exotherm (175 °C maximum temperature). A temperature of 145 °C was then established, and the reaction mixture was held for 2 hours. Component 6 was introduced slowly while allowing the mixture to cool to 125 °C, followed by addition of Component 7. A temperature of 105 °C was established, and Components 8-9 were added to the reaction mixture in rapid succession. The reaction mixture was allowed to exotherm, after which the mixture was held at 115 °C for 1 hour to yield a Resin Synthesis Product (Component 10). A portion of the Resin Synthesis Product, as Component 10, was then poured into a pre-mixed solution of Components 11-12 to form a resin dispersion, and the resin dispersion was mixed for 30 minutes. Component 13 was introduced over 30 minutes, and the dispersion was mixed for a further 30 minutes. Component 14 was then added, and the dispersion was mixed well. Free MIBK was subsequently removed from the dispersion by distillation under vacuum at a temperature of 60-70 °C, affording a product with a final solids content of 40.2%.

### Example 5. Preparation of Organic Resinous Component (Additive Resin Dispersion I)

Resin Synthesis Stage

| # | Material | Parts by Weight |
|---|---|---|
| 1 | DER 732¹ | 642.3 |
| 2 | Bisphenol A | 153.6 |
| 3 | N,N-Dimethylbenzylamine | 1.2 |
| 4 | Bis[2-(2-butoxyethoxy)ethoxy]methane² | 70.3 |
| 5 | Jeffamine D400³ | 160.8 |
| 6 | EPON 828⁴ | 17.4 |
| 7 | Bis[2-(2-butoxyethoxy)ethoxy]methane | 3.1 |

Dispersion Stage

| | | |
|---|---|---|
| 8 | Resin Synthesis Product | 901.8 |
| 9 | Sulfamic acid | 25.9 |
| 10 | Deionized water | 1131.6 |
| 11 | Deionized water | 514.9 |

¹Diglycidyl ether of polypropylene glycol with an epoxy equivalent weight of ~310-330, available from Olin.
²Available as Mazon 1651 from BASF.
³Polyether diamine, available from Huntsman.
⁴Diglycidyl ether of bisphenol A with an epoxy equivalent weight of 185-192, available from Westlake.

An organic resinous component was prepared in the following manner. Components 1-2 were mixed in a flask set up for total reflux with stirring under nitrogen. The mixture was heated to a temperature of 130 °C, and Component 3 was added, resulting in an exotherm (150 °C maximum temperature). The temperature was adjusted to 135 °C and held, monitoring epoxy equivalent weight by titration until reaching a value of 1230±30. Component 4 was then added, and a temperature of 100 °C was established. Component 5 was rapidly added, and the mixture was allowed to exotherm. A temperature of 90-100 °C was then established, and the mixture was held at this temperature, monitoring by 50% cut viscosity in propylene glycol methyl ether until the viscosity stalled, as defined by less than half a letter change in Gardner-Holdt bubble tube viscosity value over 30 minutes. After the viscosity stall was achieved, Components 6-7 were charged in sequence, and the reaction mixture was again held at 90-100 °C until the viscosity stalled by the same method, thereby affording a Resin Synthesis Product (Component 8). A portion of the Resin Synthesis Product, as Component 8, was then poured into a pre-mixed solution of Components 9-10 to form a resin dispersion, and the resin dispersion was mixed for 30 minutes. Component 11 was introduced over 30 minutes, and the dispersion was mixed for a further 30 minutes to yield the product, which has a theoretical solids content of 36%.

### Example 6. Preparation of Additive Resin Dispersion 2

| | | |
|---|---|---|
| # | Material | Parts by Weight |

Resin Synthesis Stage

| | | |
|---|---|---|
| 1 | DER 732¹ | 644.8 |
| 2 | Epon 828² | 378.0 |
| 3 | Bisphenol A | 344.0 |
| 4 | N,N-Dimethylbenzylamine | 1.6 |
| 5 | Bis[2-(2-butoxyethoxy)ethoxy]methane³ | 178.4 |
| 6 | Propylene glycol methyl ether⁴ | 56.2 |
| 7 | Diethanolamine | 35.1 |
| 8 | Jeffamine D400⁵ | 222.5 |

Dispersion Stage

| | | |
|---|---|---|
| 9 | Resin Synthesis Product | 1544.1 |
| 10 | Sulfamic acid | 56.4 |
| 11 | Deionized water | 1501.5 |
| 12 | Epon 8282 | 15.9 |
| 13 | Deionized water | 514.9 |

¹Diglycidyl ether of polypropylene glycol with an epoxy equivalent weight of 310-330 g/eq, available from Olin Corporation.
²Diglycidyl ether of bisphenol A with an epoxy equivalent weight of 185-192 g/eq, available from Westlake.
³Available as Mazon 1651 from BASF.
⁴Dowanol PM, available from Dow Chemical Co.
⁵Polyether diamine with a total amine value of 4.1-4.7 meq/g (measured value 4.49 meq/g), available from Huntsman.

Additive Resin Dispersion 2 was prepared in the following manner. Components 1-3 were mixed in a flask set up for total reflux with stirring under nitrogen. The mixture was heated to a temperature of 130 °C, and Component 4 was added, resulting in an exotherm (150 °C maximum temperature). The temperature was adjusted to 135 °C and held, monitoring epoxy equivalent weight by titration until reaching a value of 1360±30. Components 5-6 were then added, and a temperature of 100 °C was established. Component 7 was rapidly added, and the mixture was allowed to exotherm. After 20 minutes, Component 8 was rapidly added, and the mixture was again allowed to exotherm. A temperature of 90-100 °C was then established, and the mixture was held at this temperature, monitoring by 50% cut viscosity in propylene glycol methyl ether until the viscosity stalled, as defined by less than half a letter change in Gardner-Holdt bubble tube viscosity value over 30 minutes, thereby affording a Resin Synthesis Product (Component 9). A portion of the Resin Synthesis Product, as Component 9, was then poured into a pre-mixed solution of Components 10-11 to form a resin dispersion, and the resin dispersion was mixed for 30 minutes. Component 12 was then introduced and heated at 60 °C for 1 hour. Component 13 was introduced over 30 minutes, and the dispersion was mixed for a further 30 minutes to yield the product, which has solids content of 46.1%.

### Example 7. Preparation of Additive Resin Dispersion 3

| | | |
|---|---|---|
| # | Material | Parts by Weight |

Resin Synthesis Stage

| | | |
|---|---|---|
| 1 | ChemMod 68¹ | 92.6 |
| 2 | Bisphenol A | 26.5 |
| 3 | Bis[2-(2-butoxyethoxy)ethoxy]methane² | 39.2 |
| 4 | Ethyltriphenylphosphonium bromide | 0.1 |
| 5 | Propylene glycol methyl ether³ | 58.8 |
| 6 | Diethanolamine | 3.4 |
| 7 | Hypro ® 1300X42⁴ | 230.0 |
| 8 | Propylene glycol methyl ether³ | 20.4 |

Dispersion Stage

| | | |
|---|---|---|
| 9 | Resin Synthesis Product | 410.2 |
| 10 | Acetic acid | 13.9 |
| 11 | Deionized water | 411.6 |
| 12 | Deionized water | 225.1 |

¹Neopentylglycol diglycidyl ether with a typical epoxide equivalent weight of 145 g/eq, available from Cargill.
²Available as Mazon 1651 from BASF.
³Dowanol PM, available from Dow.
⁴Amine-terminated butadiene-acrylonitrile copolymer with a typical amine equivalent weight of 450 g/eq, available from Huntsman.

Additive Resin Dispersion 3 was prepared in the following manner. Components 1-3 were mixed in a flask set up for total reflux with stirring under nitrogen. The mixture was heated to a temperature of 130 °C and Component 4 was added, resulting in an exotherm (150 °C maximum temperature). After exotherm, the mixture was held at 130 °C for 2 hours. A target temperature of 100 °C was then set and Component 5 was added to aid in cooling. At 100 °C, Component 6 was added rapidly, and the mixture was allowed to exotherm for 30 minutes. At a temperature of 100 °C, pre-mixed Components 7-8 were added rapidly resulting in an exotherm. The reaction mixture was held further at 100 °C for 3 hours, thereby affording a Resin Synthesis Product (Component 9). A portion of the Resin Synthesis Product, as Component 9, was then poured into a pre-mixed solution of Components 10-11 at 50 °C to form a resin dispersion, and the resin dispersion was mixed for 30 minutes. Component 12 was introduced over 30 minutes, and the dispersion was mixed for a further 30 minutes to yield the product, which has a solids content of 33.16%.

### Example 8-Int. Preparation of Amine-Acid Salt Quaternizing Intermediate

Resin Synthesis Stage

| # | Material | Parts by Weight |
|---|---|---|
| 1 | N,N-Dimethylethanolamine | 445.0 |
| 2 | Polymeric 4,4′-methylenebis(phenyl isocyanate)¹ | 660.0 |
| 3 | Bis [2-(2-butoxyethoxy)ethoxy]methane² | 22.1 |
| 4 | Lactic acid, 88% aqueous solution | 512.0 |
| 5 | Deionized water | 2136.1 |

¹Available from Dow Chemical Co. as PAPI 2940, isocyanate (NCO) content 31.36-32.57%.
²Available as Mazon 1651 from BASF.

An amine-acid salt quaternizing intermediate was prepared in the following manner. Component 1 was mixed in a flask set up for total reflux with stirring under nitrogen. Component 2 was then added dropwise under mild agitation over 1.5 hours, followed by a rinse with Component 3. During this addition, the reaction was allowed to exotherm to a temperature of less than 90 °C and held at that temperature for 1 hour until complete reaction of the isocyanate as determined by IR spectroscopy. At that time, Component 4 was added over a period of 25 minutes followed by addition of Component 5. The reaction mixture was held at 80 °C for 6 hours until a stall was detected by acid value at 70.6, thereby affording a resin synthesis product.

### Example 8. Preparation of Additive Resin Dispersion 4

Resin Synthesis Stage

| # | Material | Parts by Weight |
|---|---|---|
| 1 | Epon 828² | 528.8 |
| 2 | Bisphenol A | 224.9 |
| 3 | Bis[2-(2-butoxyethoxy)ethoxy]methane² | 83.7 |
| 4 | Ethyltriphenylphosphonium bromide | 0.5 |
| 5 | Bis[2-(2-butoxyethoxy)ethoxy]methane² | 164.9 |
| 6 | Amine-Acid Salt Quaternizing Intermediate (Ex. 8-Int.) | 418.4 |
| 7 | Deionized water | 1428.1 |
| 8 | Bis[2-(2-butoxyethoxy)ethoxy]methane² | 334.7 |

¹Diglycidyl ether of bisphenol A with an epoxy equivalent weight of 185-192 g/eq, available from Westlake.
²Available as Mazon 1651 from BASF.

Additive Resin Dispersion 4 was prepared in the following manner: Component 1 was charged to a flask set up for total reflux with stirring under nitrogen. Under mild agitation, Component 2 was then added followed by Components 3-4. The reaction mixture was heated to 140 °C, allowed to exotherm to 180 °C, then cooled to 160 °C and held at that temperature for 1 hour. At that time the polymeric product had an epoxy equivalent weight of 982.9. The reaction mixture was then cooled to a temperature of 130 °C at which time Component 5 was added and the temperature lowered to 95°−100 °C, followed by the addition of Component 6, over a period of 15 minutes, and subsequently followed by the addition of 1428.1 parts by weight of deionized water (Component 7). The reaction temperature was held at 80 °C for approximately 6 hours until the acid number of the reaction product fell below 1.0. The resultant reaction mixture was further reduced with 334.7 parts by weight of Component 8, affording Additive Resin Dispersion 4.

### Example 9. Preparation of Additive Resin Dispersion 5

| | | |
|---|---|---|
| # | Material | Parts by Weight |

Resin Synthesis Stage

| | | |
|---|---|---|
| 1 | 2-Butoxyethanol | 149.3 |
| 2 | Propylene glycol methyl ether¹ | 100.5 |
| 3 | Butyl acrylate | 639.2 |
| 4 | Styrene | 10.0 |
| 5 | 2-hydroxypropyl methacrylate | 211.3 |
| 6 | Methyl methacrylate | 10.3 |
| 7 | Glycidyl methacrylate² | 130.3 |
| 8 | 2,4-Diphenyl-4-methyl-1-pentene | 20.3 |
| 9 | 2,2′-Azobis(2-methylbutyronitrile) | 40.2 |
| 10 | 2-Butoxyethanol | 55.1 |
| 11 | Propylene glycol methyl ether¹ | 105.2 |
| 12 | t-Butyl peroxyacetate, 50% in mineral spirits³ | 20.0 |
| 13 | Propylene glycol methyl ether¹ | 5.1 |
| 14 | N-Methylethanolamine | 62.1 |
| 15 | Bis-2-ethylhexylamine | 5.2 |

Dispersion Stage

| | | |
|---|---|---|
| 16 | Resin Synthesis Product | 1295.8 |
| 17 | Lactic acid, 88% aqueous solution | 43.3 |
| 18 | Deionized water | 842.8 |
| 19 | Deionized water | 1089.5 |

¹Dowanol PM, available from Dow Chemical Co.
²Epoxide equivalent weight of 142.2 g/eq, available from Dow Chemical Co.
³Available as Luperox 7M50 from Arkema.

Additive Resin Dispersion 5 was prepared in the following manner: Components 1-2 were mixed in a flask set up for total reflux with stirring under nitrogen. The mixture was heated to a temperature of 137 °C. Components 3-8 and Components 9-11 were pre-mixed into separate addition funnels and added the flask containing Components 1-2 dropwise over the course of 2.5 hours. After addition, the temperature was maintained at 137 °C and held for 30 minutes. Components 12-13 were pre-mixed and added to the flask over the course of 5 minutes and a temperature of 137 °C was maintained for 30 minutes. Once finished, the temperature was lowered to 120 °C and a pre-mix of Components 14-15 were added to the reaction flask, allowing for exotherm. Once exotherm had subsided, the reaction mixture was held at 120 °C for 1.5 hours, thereby affording a Resin Synthesis Product (Component 16). A portion of the Resin Synthesis Product, as Component 16, was then poured into a pre-mixed solution of Components 17-18 to form a resin dispersion, and the resin dispersion was mixed for 30 minutes. Component 19 was introduced over 30 minutes, and the dispersion was mixed for a further 30 minutes to yield the product, which has a solids content of 30.25%.

### Example 10. Preparation of Additive Resin Dispersion 6

| | | |
|---|---|---|
| # | Material | Parts by Weight |

Resin Synthesis Stage

| | | |
|---|---|---|
| 1 | 2-Butoxyethanol | 150.7 |
| 2 | Propylene glycol methyl ether¹ | 99.3 |
| 3 | Butyl acrylate | 10.1 |
| 4 | Styrene | 641.0 |
| 5 | 2-Hydroxypropyl methacrylate² | 210.0 |
| 6 | Methyl methacrylate | 10.6 |
| 7 | Glycidyl methacrylate | 130.1 |
| 8 | 2,4-Diphenyl-4-methyl-1-pentene | 20.7 |
| 9 | 2,2'-Azobis(2-methylbutyronitrile) | 40.3 |
| 10 | 2-Butoxyethanol | 55.0 |
| 11 | Propylene glycol methyl ether^{¹} | 105.1 |
| 12 | t-Butyl peroxyacetate, 50% in mineral spirits² | 20.1 |
| 13 | Propylene glycol methyl ether³ | 5.1 |
| 14 | N-Methylethanolamine | 62.1 |
| 15 | Bis-2-ethylhexylamine | 5.1 |

Dispersion Stage

| | | |
|---|---|---|
| 16 | Resin Synthesis Product | 1299.8 |
| 17 | Lactic acid, 88% aqueous solution | 43.7 |
| 18 | Deionized water | 842.2 |
| 19 | Deionized water | 1092.8 |

¹Dowanol PM, available from Dow Chemical Co.
²Available as Bisomer HPMA, GEO Specialty Chemicals
³Available as Luperox 7M50 from Arkema.

Additive Resin Dispersion 6 was prepared in the following manner: Components 1-2 were mixed in a flask set up for total reflux with stirring under nitrogen. The mixture was heated to a temperature of 137 °C. Components 3-8 and Components 9-11 were pre-mixed into separate addition funnels and added the flask containing Components 1-2 dropwise over the course of 2.5 hours. After addition, the temperature was maintained at 137 °C and held for 30 minutes. Components 12-13 were pre-mixed and added to the flask over the course of 5 minutes and a temperature of 137 °C was maintained for 30 minutes. Once finished, the temperature was lowered to 120 °C and a pre-mix of Components 14-15 were added to the reaction flask, allowing for exotherm. Once exotherm had subsided, the reaction mixture was held at 120 °C for 1.5 hours, thereby affording a Resin Synthesis Product (Component 16). A portion of the Resin Synthesis Product, as Component 16, was then poured into a pre-mixed solution of Components 17-18 to form a resin dispersion, and the resin dispersion was mixed for 30 minutes. Component 19 was introduced over 30 minutes, and the dispersion was mixed for a further 30 minutes to yield the product, which has a solids content of 31.43%.

### Example 11. Preparation of Additive Resin Dispersion 7

| | | |
|---|---|---|
| # | Material | Parts by Weight |

Resin Synthesis Stage

| | | |
|---|---|---|
| 1 | Placcel 212UA¹ | 312.3 |
| 2 | Hexahydrophthalic anhydride | 75.7 |
| 3 | Bis[2-(2-butoxyethoxy)ethoxy]methane² | 64.5 |
| 4 | Epon 828³ | 165.9 |
| 5 | Ethyltriphenylphosphonium bromide | 0.7 |
| 6 | N-Methylethanolamine | 27.5 |

Dispersion Stage

| | | |
|---|---|---|
| 7 | Resin Synthesis Product | 535.4 |
| 8 | Formic acid (90% in deionized water) | 15.9 |
| 9 | Deionized water | 549.2 |
| 10 | Deionized water | 1026.0 |
| 11 | Propylene glycol methyl ether¹ | 73.4 |

¹A polycaprolactone diol with a hydroxyl number of 89.0 mg KOH/g, available from Daicel Corporation
²Available as Mazon 1651 from BASF.
³Diglycidyl ether of bisphenol A with an epoxy equivalent weight of 185-192 g/eq, available from Westlake.
⁴Dowanol PM, available from Dow Chemical Co.

Additive Resin Dispersion 7 was prepared in the following manner: Components 1-2 were mixed in a flask set up for total reflux with stirring under nitrogen. The mixture was heated to a temperature of 100 °C and allowed to exotherm (150 °C maximum temperature). After exotherm, the mixture was then heated to 150 °C and held for 1 hour. After 1 hour, the reaction mixture was held at 150 °C until no residual anhydride was detected by IR spectroscopy, followed by addition of Component 3. Components 4-5 were added, resulting in an exotherm (150 °C maximum temperature). The temperature was maintained at 150 °C and held further for 1 hour. The reaction mixture was then cooled to 120 °C and Component 6 was added and allowed to exotherm. After exotherm, the mixture was held at 120 °C thereby affording a Resin Synthesis Product (Component 7). A portion of the Resin Synthesis Product, as Component 7, was then poured into a pre-mixed solution of Components 8-9 to form a resin dispersion, and the resin dispersion was mixed for 30 minutes. Componenta 10-11 were introduced over 30 minutes, and the dispersion was mixed for a further 30 minutes to yield the product, which has a solids content of 24.3%.

### Example 12. Preparation of Additive Resin Dispersion 8

| | | |
|---|---|---|
| # | Material | Parts by Weight |

Resin Synthesis Stage

| | | |
|---|---|---|
| 1 | Epon 828¹ | 413.6 |
| 2 | Isophthalic acid | 137.2 |
| 3 | Ethyltriphenylphosphonium bromide | 0.6 |
| 4 | Xylenes | 367.3 |
| 5 | Bis[2-(2-butoxyethoxy)ethoxy]methane² | 66.3 |
| 6 | N-Methylethanolamine | 37.9 |

Dispersion Stage

| | | |
|---|---|---|
| 7 | Resin Synthesis Product | 846.9 |
| 8 | Formic acid, 90% aqueous solution | 21.4 |
| 9 | Deionized water | 256.7 |
| 10 | Deionized water | 281.1 |
| 11 | Deionized water | 917.1 |

¹Diglycidyl ether of bisphenol A with an epoxy equivalent weight of 186-190 g/eq, available from Westlake.
²Available as Mazon 1651 from BASF.

Additive Resin Dispersion 8 was prepared in the following manner: Components 1-5 were mixed in a flask setup for total reflux with stirring under nitrogen. The mixture was heated to a temperature of 150 °C and held at 145-150 °C, monitoring epoxy equivalent weight by titration until reaching a value of 1650-1800 g/eq (obtained value=1653 g/eq). The reaction mixture was then cooled to a temperature of 120 °C, at which point Component 6 was added. The reaction was allowed to exotherm to 130 °C and then held for 1 hour at 120 °C, thereby affording a Resin Synthesis Product (Component 7). A portion of the Resin Synthesis Product, as Component 7, was poured into a pre-mixed solution of Components 8-9 to form a resin dispersion, and the resin dispersion was mixed for 30 minutes. Component 10 was introduced over 30 minutes, and the dispersion was mixed for a further 30 minutes before reduction by adding Component 11. Solvent was removed from the intermediate by vacuum distillation to obtain the product, which had a solids content of 29.1%.

### Example 13. Preparation of Additive Resin Dispersion 9

| | | |
|---|---|---|
| # | Material | Parts by Weight |

Resin Synthesis Stage

| | | |
|---|---|---|
| 1 | Polyether diol based on methylamine¹ | 332.3 |
| 2 | Polypropylene glycol, Mₙ ~760² | 322.6 |
| 3 | Glacial acetic acid | 4.2 |
| 4 | Dibutyltin dilaurate | 0.37 |
| 5 | Polymeric 4,4′-methylenebis(phenyl isocyanate)³ | 116.3 |

Dispersion Stage

| | | |
|---|---|---|
| 6 | Resin Synthesis Product | 621.0 |
| 7 | Formic acid, 90% aqueous solution | 9.6 |
| 8 | Deionized water | 627.4 |
| 9 | Deionized water | 1258.0 |

¹Available as Adiansol MA 3180 from Arkema, with a hydroxyl number of 110-130 mg KOH/g.
²Available from Covestro as Arcol PPG-725, with a hydroxyl number of 141.9-151.9 mg KOH/g.
³Available from Dow Chemical Co. as PAPI 2940, isocyanate (NCO) content 31.36-32.57%.

Additive Resin Dispersion 9 was prepared in the following manner: Components 1-4 were mixed in a flask set up for total reflux with stirring under nitrogen. The temperature was adjusted to 50 °C, and Component 5 was charged to an addition funnel. Component 5 was then added slowly over 1 hour, maintaining a reaction temperature less than 90 °C. After addition was complete, the temperature was adjusted to 100 °C, and the mixture was held for 1 hour to yield a Resin Synthesis Product (Component 6). It was verified by IR spectroscopy that no residual isocyanate remained. A portion of the Resin Synthesis Product, as Component 6, was then poured into a pre-mixed solution of Components 7-8 to form a resin dispersion, and the resin dispersion was mixed for 30 minutes. Component 9 was introduced over 30 minutes, and the dispersion was mixed for a further 30 minutes to yield the product, which had a solids content of 25.3%.

### Example 14. Preparation of Additive Resin Dispersion 10

| | | |
|---|---|---|
| # | Material | Parts by Weight |

Resin Synthesis Stage

| | | |
|---|---|---|
| 1 | N-Methyldiethanolamine | 177.8 |
| 2 | Polyethylene glycol, Mₙ ~400 | 148.3 |
| 3 | Bisphenol A adduct with ethylene oxide (~6 mol EO) | 423.4 |
| 4 | Bis[2-(2-butoxyethoxy)ethoxy]methane¹ | 131.8 |
| 5 | Glacial acetic acid | 22.4 |
| 6 | Dibutyltin dilaurate | 0.6 |
| 7 | Toluene diisocyanate | 185.4 |
| 8 | Polymeric 4,4′-methylenebis(phenyl isocyanate)² | 168.8 |

Dispersion Stage

| | | |
|---|---|---|
| 9 | Resin Synthesis Product | 938.0 |
| 10 | Formic acid, 90% aqueous solution | 60.7 |
| 11 | Deionized water | 9.8 |
| 12 | Deionized water | 1960.8 |

¹Available as Mazon 1651 from BASF.
²Available from Dow Chemical Co. as PAPI 2940, isocyanate (NCO) content 31.36-32.57%.

Additive Resin Dispersion 10 was prepared in the following manner. Components 1-6 were mixed in a flask set up for total reflux with stirring under nitrogen. The temperature was adjusted to 50 °C, and Components 7-8 were pre-mixed and charged to an addition funnel. The mixture of Components 7-8 was added slowly over 1 hour, maintaining a reaction temperature less than 90 °C. After addition was complete, the temperature was adjusted to 100 °C, and the mixture was held for 1 hour to yield a Resin Synthesis Product (Component 9). It was verified by IR spectroscopy that no residual isocyanate remained. A portion of the Resin Synthesis Product, as Component 9, was then poured into a pre-mixed solution of Components 10-11 to form a resin dispersion, and the resin dispersion was mixed for 30 minutes. Component 12 was introduced over 30 minutes, and the dispersion was mixed for a further 30 minutes to yield the product, which had a solids content of 23.6%.

### Example 15-Int. Preparation of Flow Control Resin Intermediate

| | | |
|---|---|---|
| # | Material | Parts by Weight |

Resin Synthesis Stage

| | | |
|---|---|---|
| 1 | Epon 828¹ | 1023.0 |
| 2 | Bisphenol A adduct with | 365.0 |
| | ethylene oxide (~6 mol EO) | |
| 3 | Bisphenol A | 297.0 |
| 4 | 2-Butoxyethanol | 187.2 |
| 5 | Benzyldimethylamine | 1.4 |
| 6 | Benzyldimethylamine | 3.0 |
| 7 | Diethylenetriamine diketimine² | 182.3 |
| 8 | N-Methylethanolamine | 85.2 |

Dispersion Stage

| | | |
|---|---|---|
| 9 | Resin Synthesis Product | 2144.1 |
| 10 | Glacial acetic acid | 105.9 |
| 11 | Deionized water | 1065.9 |
| 12 | Deionized water | 735.9 |
| 13 | Deionized water | 1156.4 |
| 14 | Deionized water | 867.3 |

¹Diglycidyl ether of bisphenol A with an epoxy equivalent weight of 185-192 g/eq, available from Westlake.
²Reaction product of diethylenetriamine with methyl isobutyl ketone (MIBK), 72% solids inMIBK.

The flow control resin intermediate was prepared in the following manner. Components 1-4 were mixed in a flask set up for total reflux with stirring under nitrogen. The mixture was heated to a temperature of 125 °C, and Component 5 was added, resulting in an exotherm up to 180 °C maximum temperature. While exotherming, when the reaction temperature reached 160 °C, a 1-hour hold was started; after the peak exotherm, the reaction was held at at least 160 °C during this time. After 1 hour, the mixture was cooled to 130 °C, and then Component 6 was added. The reaction mixture was held at 130 °C, monitoring epoxy equivalent weight by titration until reaching an extrapolated value of 1070 g/eq. At the predicted time for the expected epoxy equivalent weight, Components 7-8 were added rapidly, and the mixture was allowed to exotherm to 150 °C. After the peak exotherm, the temperature was adjusted to 125 °C, and the mixture was held for 1 hour, thereby affording a Resin Synthesis Product (Component 9). The Resin Synthesis Product, as Component 9, was then poured into a pre-mixed solution of Components 10-11 to form a resin dispersion, and the resin dispersion was mixed for 30 minutes. The dispersion was later reduced with Components 12-14, added in succession. Solvent was removed from the intermediate by vacuum distillation until the MIBK content was less than 0.05%, yielding the product.

### Example 15. Preparation of Flow Control Resin

| # | Material | Parts by Weight |
|---|---|---|
| 1 | Flow Control Resin Intermediate (Ex. 15-Int) | 2517 |
| 2 | Deionized water | 443 |
| 3 | Epon 828¹, 85% solution in MIBK | 44.8 |
| 4 | Methyl isobutyl ketone | 4.1 |
| 5 | Deionized water | 15.0 |

¹Diglycidyl ether of bisphenol A with an epoxy equivalent weight of 185-192 g/eq, available from Westlake.

The flow control resin was prepared in the following manner: Components 1-2 were charged to a flask set up for total reflux with stirring under nitrogen and heated to a temperature of 70 °C. Component 3 was added over 15 min, followed by Component 4. The reaction mixture was then held at this temperature for 45 min, after which it was heated to 88-90 °C and held for 3 hr. After this hold, heat was removed, and Component 5 was charged while cooling. The dispersion was mixed for at least 60 min while cooling to yield the product, which has a solids content of 18%.

### Example 16: Preparation of Electrodepositable Coating Compositions A-U

For each electrodepositable coating composition, Charges 1-6 were added sequentially into a plastic container at room temperature under agitation with 10 minutes of stirring after each addition. The mixture was stirred for at least 30 minutes at room temperature. Charge 7 was then added, and the paint was allowed to stir until uniform, a minimum of 30 minutes. Charge 8 was added, and the electrodepositable coating composition was allowed to stir for a minimum of 30 minutes until uniform. The resulting cationic electrodepositable paint compositions had a solids content of 20%, determined as by described previously, and each of the electrodepositable coating compositions had a pigment to binder weight ratio of 0.15:1.0 with the exception of electrodepositable coating composition P which had a pigment to binder weight ratio of 0.14/1.0.

| | | Parts by Weight, gram | | | | | | |
|---|---|---|---|---|---|---|---|---|
| Charge | Material | A | B | C | D | E | F | G |
| 1 | Resin Dispersion 1 | 945.41 | 946.7 | 825.45 | 826.57 | 845.37 | 846.52 | 879.69 |
| 2 | Catalyst Solution¹ | 82.75 | 82.86 | 82.75 | 82.86 | 82.75 | 82.86 | — |
| 3 | Additive Resin Dispersion 1 | — | — | — | — | 114.91 | 115.06 | 116.14 |
| | Additive Resin Dispersion 2 | — | — | 87.16 | 87.28 | — | — | — |
| 4 | Flow Control Resin² | 45.19 | 45.25 | 45.19 | 45.25 | 45.19 | 45.25 | 45.67 |
| 5 | Bis[2-(2- | 20.91 | 20.91 | 20.91 | 20.94 | 20.91 | 20.94 | 21.4 |
| | butoxyethoxy)ethoxy]methane | | | | | | | |
| 6 | DI Water | 39.78 | 39.83 | 72.58 | 72.68 | 24.92 | 24.95 | 83.54 |
| 7 | Paste 1 (Calcined Clay)³ | 174.7 | — | 174.7 | — | 174.7 | — | 151.6 |
| | Paste 2 (Hydrous Clay)⁴ | — | 173.9 | — | 173.9 | — | 173.9 | — |
| | Paste 3 (Sn Paste)⁵ | — | — | — | — | — | — | 23.9 |
| 8 | DI Water | 1190.7 | 1207.5 | 1191.3 | 1190.5 | 1208.2 | 1207.5 | 1195.4 |

¹Solution consisting of Bismuth Oxide and Methane Sulfonic acid with 4.88% bismuth on total solution weight.
²Example 15
³Pigment paste consisting of a pigment dispersion resin, calcined clay (Satintone 5HB from KaMin LLC), and carbon black with a mass ratio of clay to carbon black of 90:10. Paste pigment solids = 37.34% and Paste resin solids = 18.67%)
⁴Pigment paste consisting of a pigment dispersion resin, hydrous clay (ASP-200 from KaMin LLC), and carbon black with a mass ratio of clay to carbon black of 90:10. Paste pigment solids = 37.51% and Paste resin solids = 18.44)
⁵Catalyst paste consisting of a pigment dispersion resin and Dibutyltin Oxide where dibutyltin oxide consists of 36% of the paste total mass and the dispersion resin consists of 18% of the total mass.

| | | Parts by Weight, gram | | | | | | | |
|---|---|---|---|---|---|---|---|---|---|
| Charge | Material | H | I | J | K | L | M | N | O |
| 1 | Resin Dispersion 1 | 767.92 | 767.92 | 767.92 | 767.92 | 767.92 | 793.91 | 767.92 | 767.92 |
| 2 | Catalyst Solution¹ | 82.75 | 82.75 | 82.75 | 82.75 | 82.75 | 82.75 | 82.75 | 82.75 |
| 3 | Additive Resin | 121.29 | — | — | — | — | — | — | — |
| | Dispersion 3 | | | | | | | | |
| | Additive Resin | — | 100.55 | — | — | — | — | — | — |
| | Dispersion 4 | | | | | | | | |
| | Additive Resin | — | — | 132.95 | — | — | — | — | — |
| | Dispersion 5 | | | | | | | | |
| | Additive Resin | — | — | — | 127.96 | — | — | — | — |
| | Dispersion 6 | | | | | | | | |
| | Additive Resin | — | — | — | — | 165.51 | — | — | — |
| | Dispersion 7 | | | | | | | | |
| | Additive Resin | — | — | — | — | — | 97.86 | — | — |
| | Dispersion 8 | | | | | | | | |
| | Additive Resin | — | — | — | — | — | — | 109.17 | — |
| | Dispersion 9 | | | | | | | | |
| | Additive Resin | — | — | — | — | — | — | — | 170.42 |
| | Dispersion 10 | | | | | | | | |
| 4 | Flow Control Resin² | 45.19 | 45.19 | 45.19 | 45.19 | 45.19 | 45.19 | 45.19 | 45.19 |
| 5 | Bis[2-(2- | 20.11 | 20.11 | 20.11 | 20.11 | 20.11 | 20.11 | 20.11 | 20.11 |
| | butoxyethoxy) | | | | | | | | |
| | ethoxy]methane | | | | | | | | |
| 6 | DI Water | 79.91 | 100.65 | 68.24 | 73.24 | 35.69 | 77.35 | 92.03 | 30.78 |
| 7 | Paste 1 (Calcined | 175.5 | 175.5 | 175.5 | 175.5 | 175.5 | 175.5 | 175.5 | 175.5 |
| | Clay)³ | | | | | | | | |
| 8 | DI Water | 1207.4 | 1207.4 | 1207.4 | 1207.4 | 1207.4 | 1207.4 | 1207.4 | 1207.4 |

¹Solution consisting of Bismuth Oxide and Methane Sulfonic acid with 4.88% bismuth on total solution weight.
²Example 15
³Pigment paste consisting of a pigment dispersion resin, calcined clay (Satintone 5HB from KaMin LLC), and carbon black with a mass ratio of clay to carbon black of 90:10. Paste pigment solids = 37.17% and Paste resin solids = 18.58%).

| | | Parts by Weight, gram | |
|---|---|---|---|
| Charge | Material | P | Q |
| 1 | Resin Dispersion¹ | 818.81 | — |
| | Resin Dispersion² | — | 776.13 |
| 2 | Guanidine Catalyst Dispersion¹ | 111.21 | — |
| 3 | Additive Resin Dispersion^{¹} | 114.91 | 114.91 |
| 4 | Flow Control Resin² | 45.19 | 45.19 |
| 5 | Bis[2-(2-butoxyethoxy) | 20.91 | 20.11 |
| | ethoxy]methane | | |
| 6 | DI Water | 23.02 | 160.84 |
| 7 | Paste 1 (Calcined Clay)³ | 174.7 | — |
| | Paste 1 (Calcined Clay)⁴ | — | 175.5 |
| 8 | DI Water | 1191.3 | 1207.4 |

¹Prepared similarly to Example 15 in U.S. Pat. No. 7,842,762. The dispersion had a solids content of 36.5% by weight, and 10.9% of bicyclic guanidine catalyst 1,5,7- triazabicyclo[4.4.0]dec-5-ene by weight on total solids.
²Example 15
³Pigment paste consisting of a pigment dispersion resin, calcined clay (Satintone 5HB from KaMin LLC), and carbon black with a mass ratio of clay to carbon black of 90:10. Paste pigment solids = 37.34% and Paste resin solids = 18.67%)
⁴Pigment paste consisting of a pigment dispersion resin, calcined clay (Satintone 5HB from KaMin LLC), and carbon black with a mass ratio of clay to carbon black of 90:10. Paste pigment solids = 37.17% and Paste resin solids = 18.58%).

### Test Methods and Procedures

Determination of % aliphatic content of resin: The aliphatic content of a resin was determined based on the mass of the atoms comprising aromatic structures in a polymer and the total mass of the polymer, according to the following equation:

$$\% Aliphatic Content = \frac{Total mass of polymer - Mass of atoms in aromatic structures}{Total mass of polymer} \times 100$$

The atoms comprising aromatic structures are defined as the atoms forming the basis of the aromatic system, as described above. For example, for benzene or any mono- or poly-substituted benzene derivative, the mass of the C₆ aromatic unit is used based on the polyvalent benzene radical as shown below:

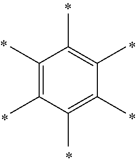

It would be known to one skilled in the art that this example is non-limiting, and this calculation can be applied to any aromatic structures, including but not limited to other monocyclic aromatic structures, polycyclic aromatic structures, and heteroaromatic structures.

As an example, the % aliphatic content by weight for Additive Resin I was determined in the following manner: Polymer components comprising aromatic structures were identified as bisphenol A and EPON 828. The aromatic portion of bisphenol A is defined as the two benzene-type aromatic rings, each contributing a C₆ aromatic structure with a mass of 72 Da. The total mass of the bisphenol A monomer is 228 Da. The % aromatic content for the bisphenol A monomer is then equal to (2 times 72)/228 times 100% which equals 63.2%. The % aromatic content of EPON 828 can similarly be calculated as 43.1%. The % aliphatic content of the polymer in Additive Resin Dispersion I was then calculated as:

$$\frac{974.1 g - ( 153.6 g * 63.2 \% + 17.4 g * 43.1 \% )}{974.1 g} * 100 \% = 89.3 \%$$

Determination of Molecular Weight by Gel Permeation Chromatography (GPC): The number average molecular weight (Mn), weight average molecular weight (Mw) and z-average molecular weight (Mz) were determined by Gel Permeation Chromatography (GPC). For polymers having a z-average molecular weight of less than 900,000, GPC was performed using a Waters 2695 separation module with a Waters 410 differential refractometer (RI detector), polystyrene standards (Agilent Technologies, EasiCal PS-2 Part No. 2010-0605, pack of 5) having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

Production of an electrodeposited coating on a substrate: Coated panels are prepared from cold rolled steel panels, 4×12×0.032 inches, pretreated with CHEMFOS C700/DI (CHEMFOS C700 is a zinc phosphate immersion pretreatment composition available from PPG Industries, Inc.) and available from ACT Laboratories of Hillside, Michigan. The electrodepositable coating composition is electrodeposited onto said metal panel by immersing them into a stirring bath at 32 degrees centigrade and connecting the cathode of a direct current rectifier to the panel and connecting the rectifier's anode to stainless steel tubing used to circulate cooling water for bath temperature control. The voltage was increased from 0 to a maximum voltage over a period of 30 seconds and then held at that voltage for an additional 150 seconds. The voltage applied to each bath is determined by the voltage that provided a cured dry film thickness of 18 microns for all paints after heating at 175 °C for 25 minutes in an electric oven (Despatch Industries, model LFD series).

Determination of Glass Transition Temperature (T_{g}) of Additive Resin by Differential Scanning Calorimetry (DSC): Samples were dried in an Aluminum pan under a fume hood until the volatiles below 5 wt-% before conducting DSC measurements. The glass transition temperature (Tg) of the samples in the Examples was determined by Differential Scanning Calorimetry (DSC) at a ramping rate of 10 C/minute. The measurement performed 2 cycles of heating and cooling with identical rate of 10 °C/minute from −90 °C to 200 °C. The midpoint of the curves (both first heat and second heat) in which heat capacity (Cp) increases from glass plateau to the rubbery plateau was taken as the Tg. The DSC instrument used for this measurement was a DSC model 2500 from TA Instruments.

Determination of Surface Roughness (Ra): The electrodepositable coating composition is electrodeposited onto a metal panel and cured, and then coating texture is evaluated using a profilometer over a specified length of the panel, filtering the roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra. A specific test procedure is performed as follows: Test panels are specially prepared from cold rolled steel panels, 4×12×0.032 inches, pretreated with CHEMFOS C700/DI and available from ACT Laboratories of Hillside, Michigan (Item Number: 28630). The electrodepositable coating composition is electrodeposited onto said metal panel and the coating cured by baking at 175 °C for 20 minutes in an electric oven (Despatch Industries, model LFD series). Each of the panels has a dry film thickness between 17 to 19 microns. The coating texture was evaluated using a Mitutoyo Surftest SJ-402 skidless stylus profilometer equipped with a 4 mN detector and a diamond stylus tip with a 900 cone and a 5 μm tip radius. The scan length, measuring speed, and data sampling interval may be 48 mm, 1 mm/s, and 5 μm, respectively. The raw data may be first filtered to a roughness profile according to ISO 4287-1997 3.1.6 using an Lc parameter of 2.5 mm and an Ls parameter of 8 μm before summarizing an Ra metric according to ISO 4287-1997 4.2.1.

Determination of Cure Performance by Gel Fraction: The coating composition was electrodeposited onto test panels are specially prepared from cold rolled steel panels, 4×12×0.032 inches, pretreated with CHEMFOS C700/DI and available from ACT Laboratories of Hillside, Michigan (Item Number: 28630). These panels were cut to a size of 2×2×0.032 inches. These panels were heated in an oven at 171 °C for 30 minutes prior to being coated. The heated panels were weighed before coating (W0). The panels were then placed into the electrodepositable composition that was at 32 °C. The panels were coated for 180 seconds including a 30 second ramp time to maximum voltage. The voltage was adjusted to obtain 18 microns film thickness after curing in an oven. After coating deposition, the panels were cured in an oven at a specified temperature for 20 minutes. The panels were then cooled to room temperature before being weighed (W1). The panels were then placed into a 1:1 by mass mixture of acetone and methanol and soaked for 24 hours at room temperature. The panels were then removed from the solution and baked at 120 °C for 20 minutes to dry the samples. Once the panels are cooled to room temperature, the panels are weighed (W2). The gel faction is calculated by the formula:

$$Gel Fraction ( \% ) = \frac{W 2 - W 0}{W 1 - W 0} \times 100$$

Determination of Impact Performance: The paints were coated on to cold rolled steel panels as described previously and cured by heating for 20 minutes in an electric oven at 155, 165, and 25 minutes 175 °C. The panels were then tested according to ASTM D2794-93. After the impact test was performed, each impact location was covered with tape (Scotch 898 from 3M Company) that was then removed quickly. The results are reported in the last impact force (in lbs) where no damage to the film is observed.

Determination of Mandrel Bend Performance: The paints were coated on to cold rolled steel panels as described previously and cured by heating for 20 minutes in an electric oven at 155, 165, and 25 minutes 175 °C. The panels were then tested according to ASTM D522/D522M-17. The results are reported millimeters from the edge of the panels with the highest degree of curvature where coating defects have occurred. A rating of 0 indicates no coating defects.

Determination of Solids (or Non-Volatile) Content: Solids content was determined as described by ASTM D2369-24.

Determination of oil absorption test method: Clay oil absorption values were determined according to ASTM D6854-12a (2014) with a C.W. Brabender Absorptometer-C using di-octyl adipate. The standard speed setting during testing is approximately 125 rpm. The standard temperature reading during mixing is approximately 23′. The burette setting is 4 mL/min. An endpoint at 70% maximum torque is used for the evaluation, applying moisture correction in the calculation. The results are reported as “ml/100 gram”.

Determination of Clay BET surface area test method: The BET surface area values reported in the examples of this application were determined in accordance with the Brunauer-Emmet-Teller (BET) method in accordance with ASTM D1993-03. The BET surface area was determined by fitting five relative-pressure points from a nitrogen sorption isotherm measurement made with a Micromeritics TriStar II Plus™ instrument. A flow Prep060™ station provided heat and a continuous gas flow to prepare samples for analysis. Prior to nitrogen sorption, the silica samples were dried by heating to a temperature of 160 °C in flowing nitrogen (P5 grade) for at least one (1) hour.

Free Film generation for DMA and Tensile test: Evaluation of Coating Gloss Transition Temperature: To obtain the glass transition temperatures, a conductive electrocoat was first used to generate free films of the example electrocoats. The formulation and use of the conductive electrocoat is detailed in the following.

The conductive electrocoat is made using commercially available PPG products under product codes CR756 and CP639. Deionized water (1959 g) was added to 2093 g of CR756 and 220 g of CP639 paste under agitation for one hour. This material was then used to electrocoat panels using the technical bulletin specifications.

The panels coated in the conductive electrocoat were then submerged in the example electrocoats and electrodeposition was carried out using the method previously described. The target film build was 18-25 microns on the vertical face of the panel. The example electrocoat was then peeled off from the conductive electrocoat panel and used to measure glass transition temperature.

DMA-baked coating T_{g} method: Glass transition temperatures (T_{g}) were measured using a dynamic mechanical analyzer (DMA) using a baked free film described above section. A TA Instruments Q800 apparatus was employed in tensile mode with a preload force of 10 mN, amplitude of 15 m (tensile strain<0.3%), static stress/dynamic stress amplitude ratio (“force tracking”) of 125%, and an oscillation frequency of 1 Hz. The samples were first cut into a rectangular shape, featuring a width of 7 mm, gauge length of 15 mm, and thickness of 25 μm. After loading each film specimen at room temperature under tensile stress, they were cooled to −100 °C, thermally equilibrated, and ramped to 250 °C at 3 °C/min. Each T_{g} value was determined by peak temperature value of loss tangent (tan δ).

Tensile test (elongation at break, and tensile strength): The elongation at break (%) and tensile strength of the cured coatings prepared as described for a free film were determined by ASTM D638 by using a Instron 4443 model at room temperature. The tensile elongations at break (%) were determined by the maximum strain values, and tensile strength values were determined by the maximum stress values in the stress-strain curve. 100 N load cell was used and strain rate of 100 mm/min was applied.

The results are provided in the following tables:

Performance of coating compositions with varying aliphatic content and pigments: A-G

| | | Ex. A | Ex. B | Ex. C | E. D | Ex. E | Ex. F | Ex. G |
|---|---|---|---|---|---|---|---|---|
| Additive | Aliphatic Content | None | None | 76.0% | 76.0% | 89.3% | 89.3% | 89.3% |
| Resin | Mn | — | — | 4,815 | 4,815 | 6,400 | 6,400 | 6,400 |
| | Mw | — | — | 16,508 | 16,508 | 92,022 | 92,022 | 92,022 |
| | Mz | — | — | 41,259 | 41,259 | 389,242 | 389,242 | 389,242 |
| | Tg (°C) - 2nd heat | None | None | 1 | 1 | −32 | −32 | −32 |
| Paste | Hydrous Clay | — | x | — | x | — | x | — |
| Pigment | Calcined Clay | x | — | x | — | x | — | x |
| | Mohs Hardness | >2.5 | ≤2.5 | >2.5 | ≤2.5 | >2.5 | ≤2.5 | >2.5 |
| | Oil Absorption | 65.5 | 9 | 65.5 | 9 | 65.5 | 9 | 65.5 |
| | BET Absorption | 12.8 | 19.8 | 12.8 | 19.8 | 12.8 | 19.8 | 12.8 |
| Catalyst | Bismuth | x | x | x | x | x | x | — |
| | Tin | — | — | — | — | — | — | x |
| Coating | Appearance (Ra) | 0.336 | 0.287 | 0.202 | 0.248 | 0.380 | 0.500 | 0.382 |
| Perf. | Cure Performance | 79.40% | 82.50% | 88.70% | 92.50% | 72.30% | 73.60% | 62.50% |
| | (155 °C) | | | | | | | |
| | Impact | 0 | 0 | 80 | 0 | 140 | 0 | 40 |
| | Performance - | | | | | | | |
| | 155 °C Cure | | | | | | | |
| | Impact | 20 | 0 | 60 | 0 | 160 | 0 | 100 |
| | Performance - | | | | | | | |
| | 165 °C Cure | | | | | | | |
| | Impact | 100 | 0 | 80 | 0 | 160 | 0 | 100 |
| | Performance - | | | | | | | |
| | 175 °C Cure | | | | | | | |
| | Mandrel Bend - | 2 | 25 | 8 | 30 | 2 | 20 | 38 |
| | 155 °C Cure | | | | | | | |
| | Mandrel Bend - | 3 | 26 | 20 | 25 | 0 | 18 | 10 |
| | 165 °C Cure | | | | | | | |
| | Mandrel Bend - | 10 | 30 | 32 | 25 | 10 | 20 | 28 |
| | 175 °C Cure | | | | | | | |
| Coating | Elongation at | 2.13% | 0.91% | 2.63% | 0.92% | 3.49% | 0.63% | 3.40% |
| Property | Break | | | | | | | |
| | Tensile Strength | 50 | 9.4 | 60.31 | 8.4 | 52.8 | 11.60 | 61.4 |
| | DMA Tg 1 | 122 | 122 | 109 | 110 | 112 | 114 | 114 |
| | DMA Tg 2 | −63 | −63 | −65 | −65 | −61 | −68 | −62 |
| | Tg 1 − Tg 2 | 185 | 185 | 174 | 175 | 173 | 182.00 | 176 |

The results in the above table show that combining the pigment of calcined clay with an additive resin with a high aliphatic content improves with impact and mandrel bend performance while maintaining cure and appearance performance. Also, when bismuth is used as a catalyst, improved performance in cure, impact, and mandrel bend performance compared to tin catalyzed systems was found.

Performance of coating compositions with alternative polymers with high aliphatic content H-O

| | | Ex. H | Ex. I | Ex. J | Ex. K | Ex. L | Ex. M | Ex. N | Ex. O |
|---|---|---|---|---|---|---|---|---|---|
| Additive | Aliphatic | 95% | 55.60% | 98.30% | 60% | 97% | 56.20% | 91.30% | 72.00% |
| Resin | Content | | | | | | | | |
| | Mn | 4,228 | 11,294 | 4,675 | 5,951 | 3,713 | 4,898 | 7,453 | 2,306 |
| | Mw | 47,431 | 108,552 | 18,802 | 21,709 | 10,407 | 8,392 | 25,145 | 5,555 |
| | Mz | 215,639 | 373,544 | 50,344 | 62,017 | 25,293 | 15,171 | 87,521 | 13,519 |
| | Tg (°C) - | NA | 0 | −29 | 25 | −51 | 19 | −52 | −34 |
| | 2nd heat | | | | | | | | |
| Paste | Hydrous | — | — | — | — | — | — | — | — |
| Pigment | Clay | | | | | | | | |
| | Calcined | x | x | x | x | x | x | x | x |
| | Clay | | | | | | | | |
| Catalyst | Bismuth | x | x | x | x | x | x | x | x |
| Coating | Appearance | 0.441 | 0.541 | 0.201 | 0.430 | 0.213 | 0.396 | 0.309 | 0.79 |
| Perf. | (Ra) | | | | | | | | |
| | Cure | 94.70% | 82.40% | 90% | 88.50% | 93.10% | 76.30% | 89.30% | 91.10% |
| | Performance | | | | | | | | |
| | (165 °C) | | | | | | | | |
| | Impact | 160 | 20 | 80 | 80 | 160 | 0 | 100 | 0 |
| | Performance - | | | | | | | | |
| | 165 °C | | | | | | | | |
| | Cure | | | | | | | | |
| | Impact | 120 | 80 | 100 | 40 | 160 | 100 | 100 | 20 |
| | Performance - | | | | | | | | |
| | 175 °C | | | | | | | | |
| | Cure | | | | | | | | |
| | Mandrel | 0 | 14 | 6 | 13 | 3 | 81 | 4 | 12 |
| | Bend - | | | | | | | | |
| | 165 °C | | | | | | | | |
| | Mandrel | 8 | 29 | 9 | 30 | 3 | 5 | 6 | 29 |
| | Bend - | | | | | | | | |
| | 175 °C | | | | | | | | |
| Coating | Elongation | 2.51% | 1.69% | 1.76% | 2.65% | 2.87% | 1.05% | 2.09% | 1.44% |
| Property | at Break | | | | | | | | |
| | Tensile | 47.48 | 35.6 | 37.2 | 57.69 | 60.76 | 40 | 42.9 | 18.49 |
| | Strength | | | | | | | | |
| | DMA Tg 1 | 119 | 113 | 118 | 121 | 107 | 99 | 113 | 119 |
| | DMA Tg 2 | −56 | −59 | −61 | −62 | −59 | −68 | −61 | −59 |
| | TG 1 − Tg 2 | 175 | 172 | 179 | 183 | 166 | 167 | 174 | 178 |

The results in the above table show improved impact performance with high levels of aliphatic content for multiple types of additive resins. The impact, mandrel bend, and appearance was improved for each type of resin additive demonstrating the applicability of the polymer structure and pigmentation across a variety of compositions.

Performance of coating compositions
with alternative catalysts P-Q

| | | Example P | Example Q |
|---|---|---|---|
| | OH Value (theory) | 108 | 108 |
| | Tg (°C)-2nd heat | −32 | −32 |
| Paste Pigment | Hydrous Clay | — | — |
| | Calcined Clay | x | x |
| Catalyst | Amine | x | — |
| | Zinc | — | x |
| Coating | Appearance (Ra) | 0.142 | 0.136 |
| Performance | Cure Performance | 83.90% | 66.40% |
| | (165 °C) | | |
| | Impact Performance- | 160 | 160 |
| | 175 °C Cure | | |
| | Mandrel Bend- | 3 | 0 |
| | 175 °C | | |
| Coating | Elongation at Break | 1.80% | 2.72% |
| Property | Tensile Strength | 40.1 | 30.6 |
| | DMA Tg 1 | 90 | 91 |
| | DMA Tg 2 | −66 | −61 |

The results in the above table show improved impact performance for formulation with high levels of aliphatic content and calcined clay for organic and zinc-based catalysts. The performance improvement was able to be achieved with multiple types of non-tin-based catalysts.

Performance of coating compositions with low cure performance R-U

| | | Ex. R | Ex. S | Ex. T | Ex. U |
|---|---|---|---|---|---|
| Additive Resin | Aliphatic Content | None | None | 89.3% | 89.3% |
| | Mn | — | — | 6,400 | 6,400 |
| | Mw | — | — | 92,022 | 92,022 |
| | Mz | — | — | 389,242 | 389,242 |
| | Tg (°C)-2nd heat | None | None | −32 | −32 |
| Paste Pigment | Hydrous Clay | — | x | — | x |
| | Calcined Clay | x | — | x | — |
| Catalyst | Bismuth | x | x | x | x |
| | Tin | — | — | — | — |
| Coating | Appearance (Ra) | 0.226 | 0.236 | 0.204 | 0.257 |
| Performance | Cure Performance | 86.90% | 88.20% | 85.70% | 87.80% |
| | (140 °C) | | | | |
| | Impact Performance- | 20 | 0 | 140 | 0 |
| | 140 °C Cure | | | | |
| | Impact Performance- | 80 | 0 | 80 | 0 |
| | 150 °C Cure | | | | |
| | Impact Performance- | 60 | 0 | 80 | 0 |
| | 175 °C Cure | | | | |
| | Mandrel Bend-155 °C | 3 | 95 | 0 | 34 |
| | Mandrel Bend-165 °C | 0 | 70 | 0 | 26 |
| | Mandrel Bend-175 °C | 22 | 59 | 11 | 34 |
| Coating Property | Elongation at Break | 2.31% | 0.74% | 3.81% | 1.21% |
| | Tensile Toughness | 0.47 | 0.03 | 1.15 | 0.05 |
| | Tensile Strength | 34.16 | 7.87 | 48.95 | 8.08 |
| | DMA Tg 1 | 135 | 129 | 128 | 123 |
| | DMA Tg 2 | −66 | −67 | −53 | −60 |

The results in the above table demonstrate improvement in impact performance, appearance, and mandrel bend with low-temperature cure capability when high aliphatic content additive resins and calcined clay is used in a formulation.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
an active hydrogen-containing, ionic salt group-containing film-forming polymer;
a curing agent;
at least one organic resinous component different than the active hydrogen-containing, ionic salt group-containing film-forming polymer and curing agent, wherein the organic resinous component has an aliphatic content of at least 60% by weight, based on the total weight of the organic resinous component;
a curing catalyst comprising a bismuth-containing curing catalyst, an amine-containing curing catalyst, a zinc-containing curing catalyst, a zirconium-containing catalyst, a cerium-containing catalyst, an amidine-containing catalyst, an imidazole-containing catalyst, and/or a titanium-containing catalyst; and
calcined clay pigment.

2. The electrodepositable coating composition of claim 1, wherein the active hydrogen-containing, ionic salt group-containing film-forming polymer has an aromatic content of at least 10% by weight, based on the total weight of the active hydrogen-containing, ionic salt group-containing film-forming polymer.

3. The electrodepositable coating composition of claim 1, wherein the organic resinous component comprises cationic and/or cationic salt groups.

4. The electrodepositable coating composition of claim 1, wherein the organic resinous component comprises an amine.

5. The electrodepositable coating composition of claim 1, wherein the aliphatic content of the organic resinous component comprises:
a polyether;
a polyalkylene glycol;
a poly(alkyl-1,2-diol);
polypropylene oxide;
an aliphatic compound having two or more epoxide functional groups reacted with an aliphatic compound having one or more amine functional groups; and/or
a combination thereof.

6. The electrodepositable coating composition of claim 1, wherein the organic resinous component has:
a glass transition temperature of <0 °C;
a hydroxyl value of <130 mg KOH/g organic resinous component;
a z-average molecular weight (M_{z}) of at least 10,000 g/mol;
a weight average molecular weight (M_{w}) of at least 5,000 g/mol; and/or
a number average molecular weight (Mₙ) of at least 2,000 g/mol.

7. The electrodepositable coating composition of claim 1, wherein the organic resinous component comprises a polyetheramine adduct.

8. The electrodepositable coating composition of claim 7, wherein the polyetheramine adduct comprises an ungelled ionic reaction product prepared from reactants comprising: (a) a reaction product prepared from reactants comprising: (1) a di-functional chain extender; and (2) an epoxy functional material; and (b) a polyetheramine.

9. The electrodepositable coating composition of claim 8, wherein:
the di-functional chain extender comprises bisphenol A, bisphenol F, resorcinol, dihydroxy benzene, aliphatic, cycloaliphatic or aralaphatic hydroxyl containing compounds, such as ethylene glycol, propylene glycol, dihydroxyl cyclohexane, dimethylol cyclohexane, or combinations thereof;
the epoxy-functional material comprises a di- or polyglycidyl ether of a polyhydric alcohol, such as a polyglycidyl ether of bisphenol A; and/or
the polyetheramine comprises an aminated polymer comprising propylene oxide, ethylene oxide, or mixed propylene oxide and ethylene oxide repeating units, such as aminated propoxylated pentaerythritols or any according to Formula (I), (II), or (III), or combinations thereof: 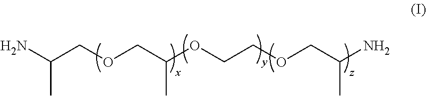
wherein y=0-39, x+z=1-68; 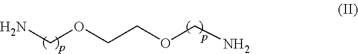
wherein each p independently is 2 or 3; or 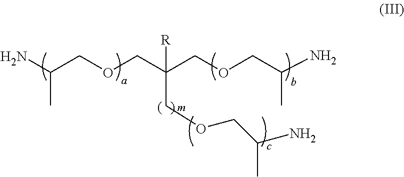
wherein R is H or C₂H₅, m=0 or 1, a+b+c=5-85.

10. The electrodepositable coating composition of claim 7, wherein the polyetheramine adduct has a polypropylene oxide content of at least 60% by weight, based on the total weight of the polyetheramine adduct.

11. The electrodepositable coating composition of claim 1, wherein the organic resinous component comprises an acrylic polymer, a polyester, and/or a urethane.

12. The electrodepositable coating composition of claim 1, wherein the calcined clay is present in an amount such that the calcined clay pigment-to-binder ratio is at least 0.1.

13. The electrodepositable coating composition of claim 1, wherein the calcined clay has an oil absorption of greater than 10 mL per 100 g, determined according to ASTM D6854-12a (2014).

14. The electrodepositable coating composition of claim 1, wherein the calcined clay has a BET surface area of less than 19 m²/g.

15. The electrodepositable coating composition of claim 1, wherein the electrodepositable coating composition is substantially free of catalytic tin.

16. An electrodepositable coating composition comprising:
an active hydrogen-containing, ionic salt group-containing film-forming polymer;
a curing agent;
at least one organic resinous component different than the active hydrogen-containing, ionic salt group-containing film-forming polymer and curing agent, wherein the organic resinous component has an aliphatic content of at least 60% by weight, based on the total weight of the organic resinous component; and
calcined clay pigment;
wherein the electrodepositable coating composition is substantially free of catalytic tin.

17. A method of coating a conductive substrate comprising applying the electrodepositable coating composition of claim 1 to at least a portion of a surface of the conductive substrate.

18. A coated substrate coated by the method of claim 17.

19. A coated substrate comprising:
an electrodeposited binder comprising:
a reaction product of an active hydrogen-containing, ionic salt group-containing film-forming polymer and a curing agent;
at least one organic resinous component different than the active hydrogen-containing, ionic salt group-containing film-forming polymer and curing agent, wherein the organic resinous component has an aliphatic content of at least 60% by weight, based on the total weight of the organic resinous component;
a curing catalyst comprising a bismuth-containing curing catalyst, an amine-containing curing catalyst, a zinc-containing curing catalyst, a zirconium-containing catalyst, a cerium-containing catalyst, an amidine-containing catalyst, an imidazole-containing catalyst, and/or a titanium-containing catalyst; and
calcined clay pigment.

20. A use of the electrodepositable coating composition of claim 1 for making a coating having at least one of:
an elongation at break of at least 1.25%;
a tensile toughness of at least 0.5 MPa;
an electrodeposited binder comprising a first resin domain and a second resin domain;
an electrodeposited binder comprising:
a first resin domain having a first glass transition temperature; and
a second resin domain having a second glass transition temperature, wherein the first glass transition temperature is at least 10 °C greater than the second glass transition temperature, and the second glass transition temperature is greater than −50 °C; and/or
an electrodeposited binder comprising:
a first resin domain having a first glass transition temperature of at least 80 °C; and
a second resin domain having a second glass transition temperature of from −50 °C to 70 °C.
